(19) United States
(12) Patent Application Publication
(10) Pub. No.: US 2008/0040146 A1
(43) Pub. Date: Feb. 14, 2008

(54) Platform-independent systems and methods for enabling parties to rapidly negotiate terms for a service to be provided by one party to another party, and to effect payment between parties upon completion thereof

(76) Inventor: Steve Rogovin, Arlington, VA (US)

Correspondence Address: BRYAN CAVE LLP, 211 NORTH BROADWAY, SUITE 3600, ST. LOUIS, MO, 63102-2750, US

(21) Appl. No.: 11/888,712

(22) Filed: Aug. 2, 2007

Related U.S. Application Data
(60) Provisional application No. 60/836,826, filed on Aug. 10, 2006.
(60) Provisional application No. 60/836,766, filed on Aug. 10, 2006.

(51) Int. Cl. G06Q 30/00

(52) U.S. Cl. 705/1

(57) ABSTRACT

The invention provides platform-independent non-proprietary systems and methods to enable parties to utilize one or more conventional communication applications/systems, in one or more mediums, to easily negotiate one or more aspects of a provision of a desired service by one of the parties, and to effect the appropriate compensation, after the service is provided, to the appropriate party, and, optionally, to the party enabling the service procurement process. In another embodiment of the invention, the systems and methods enable a party to readily locate a desired service from a service information database or directory (by browsing and/or searching), to select a desired service and corresponding prospective provider, to communicate therewith to readily and flexibly negotiate the cost of the service and/or one or more non-financial aspects of the service provision, and to effect compensation for the service after provision thereof. In yet another embodiment of the invention, the systems and methods are utilized to add one or more of the service procurement, negotiation, provision, and compensation features to an existing application and/or data processing infrastructure, such that the various communication and other features thereof may be advantageously utilized in conjunction with the systems and methods described herein.

### CROSS-REFERENCE TO RELATED APPLICATIONS

This application claims priority to, and incorporates by reference, U.S. Provisional Patent Application Ser. Nos. 60/836,826 and 60/836,766, both filed on Aug. 10, 2006.

### FIELD OF THE INVENTION

The present invention relates generally to systems and methods for enabling parties to request, receive, and/or provide services, and payment therefor, between one another. More particularly, the present invention relates to communication platform-independent systems and methods for enabling, in an interactive application environment, one party to locate another party seeking to provide desired services, to conduct negotiations with the service provider, and to effect payment for the services.

### BACKGROUND OF THE INVENTION

In recent years, the popularity of the Internet (and, specifically, the World Wide Web), coupled with incredible growth in availability and accessibility of high-bandwidth Internet connections, resulted in an unprecedented abundance of fast and powerful software and hardware tools, and the necessary supporting infrastructure that enabled affordable and high-quality real-time online electronic, audio, and video interaction between a great number of users over vast distances. The results of continuous evolution of these interactions and information exchange technologies readily filtered down to various online interaction/communication applications, tools, and infrastructures, such as chat-rooms, online forums, groups, clubs, media sharing websites, instant message clients, video conferencing, and so on.

The few companies that had the vision and wherewithal to capitalize on these trends became enormously successful by organizing the ever-growing ocean of content, by building wide-ranging data processing infrastructure (that included, inter alia, distributed applications, specialized hardware and middleware applications) to provide users with intuitive and powerful tools to navigate, filter, search, and otherwise interact with available information. These now-famous companies, commonly referred to as “Internet portals,” also immediately recognized the great value of keeping each and every user within their grasp “clicking” on their revenue-generating advertisements. Accordingly, these companies began to offer their users even more content (videos, news, music, etc.), tools, services (free email, free data storage, etc.), and even software applications (media management, desktop search, etc.).

Not surprisingly, in addition to changes to on-line social dynamics, technological advancements in high-bandwidth data transmission and communications were seen by some as heralds of new business opportunities and foundations for entirely new areas of commerce. Thus, in parallel with the spread of online retailers and auction websites, a number of commercial applications that purported to take advantage of readily available high-speed interpersonal interaction capabilities were developed.

As many anticipated, the concept of providing compensated services from one party to another over the Internet generated considerable interest, especially from the often overlooked, but profitable, adult entertainment industry. Very quickly, live “web-cams”, interactive streamed videos, and video chat-rooms were added to the stables of offerings of many such businesses.

More conventional business applications were not far behind, and soon, powerful tools for collaboration, conducting presentations, remote training, and even hosting online meetings between remote participants became a reality. In particular, many felt that commercialization of compensated remote provision of business services (such as financial, medical, and legal advice, training, premium technical support, counseling, etc.), especially within the wide-ranging user community (rather than by specific dedicated organizations), was the next frontier of e-commerce with a potential that would eventually rival the online product retailer industry.

However, for a number of reasons, outside of stable, but not particularly impressive, growth in the aforementioned adult industry, the “online services” revolution never took place. Very likely, this lack of expected success is due to the fact that the vast majority of proposed solutions for remote compensated service provision suffered from a number of drawbacks, at least some of which are discussed below (by way of example).

First, many of such offerings were proprietary to the solution provider, in whole or in part (either being a custom application, and/or requiring a specific installed communication protocol), which greatly limited their usefulness and popularity. Indeed, many potential users were disinclined to learn yet another communication application, or did not trust the particular selected payments system. The proprietary approach was taken by the solution providers because they each wanted to quickly and decisively take control of the service market by making their application the de facto standard.

In other cases, rather than requiring users to install proprietary applications, or to utilize a particular web-based application, certain solutions required users to download modules (e.g., “applets”, or “plug-ins”) that had to be integrated into the users' web browser in order to utilize the particular service provision system. In many cases, these modules were unstable (resulting in web browser and/or computer crashes). In other cases, these downloadable modules had major exploitable security holes, and some even had malicious codes (such as spyware or adware). Many users refused to take any risk with unproven browser modules, and as a result, these solutions did not gain much traction in the marketplace.

In addition to, and in some cases instead of, being proprietary in their infrastructure and operation, other proposed solutions imposed many rules and restrictions on the nature of services that may be sold between users, their manner of delivery, and the fees charged.

In an attempt to capitalize on certain niche markets and to attract a certain desirable class of users, other proposed inter party commercial service solutions were developed, specifically for a single-type of service (such as medical or legal advice), to the exclusion of other possibilities. While some achieved limited success, these applications also typically suffered from other above-described drawbacks.

Virtually all previously-known and attempted solutions were fixated on handling all aspects of commercial services provision in the online (i.e., Internet) domain, from requesting a service, to paying for it, to delivering it. This strategy enabled the providing entity to exercise full control over the entire process. However, this consistent outlook completely ignored the possibility that certain aspects of the service acquisition and delivery process can take place in other “mediums” such as face-to-face, over the telephone, etc., or even in a user's backyard (for example, if the user wanted to hire a house painter online).

The above-noted desire of many solution providers to maintain control over all aspects of the service procurement, provision, and compensation process, often resulted in the providers having to handle the content flow between service providers and recipients (e.g., audio/video streams, chat communications, etc.), which had at least two drawbacks. Specifically, such approach suffered from the cost of carrying the bandwidth, and the responsibility for the nature and content of the communication, not to mention the privacy issues, if the service-related content was somehow disseminated.

Furthermore, most offerings were structured to clearly distinguish between users who sought services, and “expert” service providers who offered and provided them, thereby completely excluding the concept of “exchange” of services (and dual roles of consumer and provider) that many users were capable of performing.

The often cumulative effect of the above-described drawbacks restricted the number of users drawn to any particular solution, and, as expected, resulted in a closed-loop effect of an offered compensated service procurement and provision application having a number of available service providers too small to attract enough users, and an insufficient quantity of active users to attract the needed service providers.

Notwithstanding the above-described setbacks, design flaws, and mistakes, attempts at achieving success in the compensated inter party service procurement and provision field continued. In particular, one approach, proposed only by a very small number of solution providers, seemed to offer a very attractive feature to many users. Specifically, the solution providers experimented with the concept of facilitating negotiation between a party seeking to purchase a service (the “Buyer”), and a party seeking to sell the service (the “Seller”). The term “client” is also used herein to refer to “Buyers.”

In theory, this proposed feature brought an aspect of excitement to the compensated service process in that Buyer participants could feel a sense of accomplishment at getting a service at a bargain rate, and, similarly, Seller participants would get access to a wider number of customers, simply by controlled lowering of their fees. However, even this technique did not result in measurable success for the several solutions that employed it, because not only did those solutions each suffer from at least several of the above-described flaws, but also because in many cases the solutions compromised and restricted the implementation of negotiation as a feature of service procurement. Such restrictions were manifested in many forms—for example, the required use of a complex service seller usage fee structure that makes true real-time negotiation difficult, as the seller is hard-pressed to constantly recalculate the fees due to the solution provider. In addition, in virtually every case, negotiation related only to the fees for services, and not to any other aspects of service provision (such as timeliness, quality, speed, etc.). As such, even today, the long-felt demand for a successful compensated service procurement and provision business remains as unsatisfied.

In light of the foregoing, it is desirable to provide a platform-independent nonproprietary system and method for enabling parties to utilize one or more conventional communication applications/systems, in one or more mediums, to easily negotiate one or more aspects of desired service provision, and to effect the appropriate compensation after the provision thereof. It would also be desirable to provide a platform-independent non-proprietary system and method for enabling a party to readily locate a desired service, to select and communicate with a prospective service provider, to readily and flexibly negotiate the cost of the service, and/or one or more non-financial terms of service provision, and to effect compensation for the service after provision thereof.

In addition, it would be desirable to provide a system and method for adding one or more aspects of the above-described systems and methods to an existing application and/or data processing infrastructure—to provide the beneficial service procurement, negotiation and compensation, therefor. Still further, it would be desirable to provide a platform-independent system and method for adding a dynamic real-time service terms negotiation feature to an existing communication application, capable of supporting provision of compensated services therethrough, and of effecting the negotiated payment to the service provider thereafter.

### SUMMARY OF THE INVENTION

According certain embodiments of the present invention, methods and systems for delivering services are provided. Such methods and systems generally comprise (a) establishing a connection with a client using a communication device that is selected or approved by the client among a plurality of communication device options; (b) negotiating and agreeing upon at least one term pursuant to which services will be rendered to the client; (c) initiating a service session using the communication device; and (d) monitoring the duration of the service session using a tool that is accessed via a data processing system. The invention provides that such tool is capable of monitoring the duration of the service session, which employs any of the above-mentioned communication device options or combinations thereof.

According to additional embodiments of the invention, systems for delivering services are provided. More particularly, the systems generally comprise a communication device that is selected or approved by a client among a plurality of communication device options, wherein the communication device is capable of establishing a connection with a service provider. The systems further comprise a data processing system, which is capable of accessing and displaying a website that presents a graphical user interface (GUI). The GUI includes (i) one or more controls that enable the client and service provider to negotiate and agree upon at least one term pursuant to which services will be rendered to the client; and (ii) a tool that is capable of monitoring the duration of the service session which employs any of the communication device options (or combinations thereof) selected and/or used by the client and service provider.

The above-mentioned and additional features of the present invention are further illustrated in the Detailed Description contained herein.

### BRIEF DESCRIPTION OF THE DRAWINGS

The file of this patent application contains at least one drawing executed in color. Copies of any patent to issue from this application with color drawing(s) will be provided by the United States Patent and Trademark Office upon request and payment of the necessary fee. In the drawings, wherein like reference characters denote elements throughout the several views:

FIG. 1 is a schematic diagram of a first exemplary embodiment of a service procurement and provision system, which implements a platform-independent system for service procurement negotiation and optional service provision compensation capable of operating in at least one medium.

FIG. 2 is a schematic diagram of a second exemplary embodiment of the implementation of the platform-independent system of FIG. 1, in a full-featured, non-proprietary, platform-independent service promoting, procurement, and compensation system.

FIG. 3A is a schematic diagram of a third exemplary embodiment of the implementation of the platform-independent system of FIG. 1 in a full-featured, third party content portal infrastructure that may include service promoting, procurement, and compensation features.

FIG. 3B is a diagram of an exemplary embodiment of graphical user interfaces for negotiation of service provision terms, provided to each party utilizing the platform-independent systems of FIG. 1 or 2.

FIG. 4 is a table of exemplary information that may be associated with a user account of a user of the systems of FIGS. 1 to 3.

FIG. 5 is a table of exemplary possible attributes of a service that may be offered and/or procured using the systems of FIGS. 1 to 3.

FIG. 6 is a logic flow diagram showing an exemplary embodiment of a process for procuring a desired service that may be performed in conjunction with operation of the systems of FIGS. 1 to 3.

FIG. 7A is a logic flow diagram showing an exemplary embodiment of a process for utilizing the platform-independent system of FIG. 1 in a third party data processing infrastructure.

FIG. 7B is a logic flow diagram showing an exemplary embodiment of a process for monitoring and optionally controlling a service provision session between the parties utilizing the platform-independent system of FIG. 1 or 2.

FIG. 8 is a diagram of an exemplary embodiment of a graphical user interface (GUI) for receiving information about a service provision session, and for controlling the service provision session, provided to each party utilizing the platform-independent system of FIG. 1 or 2.

FIG. 9 is a non-limiting example of a GUI showing, among other things, a tool capable of measuring and recording the duration of a service provision session, an online form that may be used to access a Buyer or Seller account, an online form that allows users to search for particular Sellers.

FIG. 10 is a non-limiting example of a GUI showing an online form that may be used to begin the process of establishing a Buyer and/or Seller account with a system of the present invention.

FIG. 11 a non-limiting example of a GUI showing an online form that may be used to add a Seller profile to an existing Seller account.

FIG. 12 is a non-limiting example of a GUI showing an embodiment of a platform-independent tool capable of measuring and recording the duration of a service provision session.

FIG. 13 is a non-limiting example of a GUI showing the tool of FIG. 12 along with an online form that Sellers and Buyers may use to negotiate a term pursuant to which services may rendered, such as the proposed fees that are requested by the Seller.

FIG. 14 is another non-limiting example of a GUI showing the tool of FIG. 12 along with an online form that Sellers and Buyers may use to negotiate a term pursuant to which services may rendered, such as the proposed fees that are requested by the Seller.

FIG. 15 is another non-limiting example of a GUI showing the tool of FIG. 12 during a live service session.

FIG. 16 is another non-limiting example of a GUI showing the tool of FIG. 12 in which a service session has been paused by the Seller.

FIG. 17 is a non-limiting example of a GUI showing, among other things, the tool of FIG. 12 following a completed service session, along with an online form that may be used by the Buyer to pay the Seller a “tip” or additional fees and to leave feedback for the Seller.

FIG. 18 is a non-limiting example of a GUI showing an online form that may be used to update and/or edit a Seller's profile page.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

The systems and methods of the present invention advantageously overcome one or more of the drawbacks of previously-known compensated service procurement, negotiation, and/or provision solutions by providing platform-independent non-proprietary systems and methods that enable parties to utilize one or more conventional communication applications, systems, methods, and devices, in one or more mediums, to easily negotiate one or more terms of provision of a desired service by one of the parties, and to effect the appropriate compensation, after the service is provided, to the appropriate party (and, optionally, to a party enabling the service procurement process).

According to certain embodiments of the present invention, methods and systems for delivering services are provided. Such methods and systems generally comprise (a) establishing a connection with a client using a communication device that is selected or approved by the client among a plurality of communication device options; (b) negotiating and agreeing upon at least one term pursuant to which services will be rendered to the client; (c) initiating a service session using the communication device; and (d) monitoring the duration of the service session using a tool that is accessed via a data processing system.

The invention provides that such tool is capable of monitoring the duration of the service session, which employs any of the above-mentioned communication device options (or combinations thereof, such that the tool may operate in a platform-independent manner, i.e., it will function regardless of the communication device(s) employed during the service session by the client and service provider.

According to additional embodiments of the invention, systems for delivering services are provided. More particularly, the systems generally comprise a communication device that is selected or approved by a client among a plurality of communication device options, wherein the communication device is capable of establishing a connection with a service provider. The systems further comprise a data processing system (such as, but not limited to, a personal computer, a PDA, and the like), which is capable of accessing and displaying a website that presents a graphical user interface (GUI). The GUI includes (i) one or more controls that enable the client and service provider to negotiate and agree upon at least one term pursuant to which services will be rendered to the client; and (ii) a platform-independent tool that is capable of monitoring the duration of the service session which employs any of the communication device options (or combinations thereof selected and/or used by the client and service provider.

In certain embodiments of the present invention, the systems and methods enable a party to readily locate a desired service from a service provider database or directory, based on information provided by parties offering the services, by browsing and/or searching, to select a desired service and a corresponding prospective service provider, and to communicate therewith to readily and flexibly negotiate the cost of the service and/or of one or more non-financial terms of the service provision (e.g., time and place of service, urgency, quality, scope, etc.), and to effect compensation for the service after provision thereof.

In yet other embodiments of the invention, the systems and methods are utilized to add one or more of the service procurement, negotiation, provision, and compensation features to an existing application and/or data processing infrastructure, such that the various communication and other features thereof, may be advantageously utilized in conjunction with the systems and methods described herein.

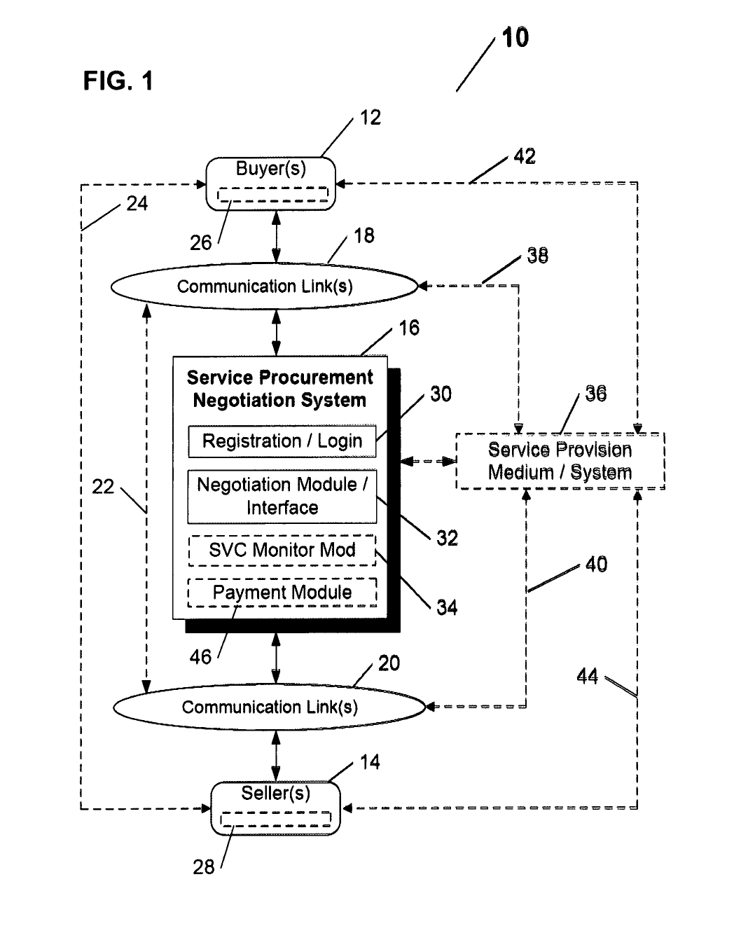

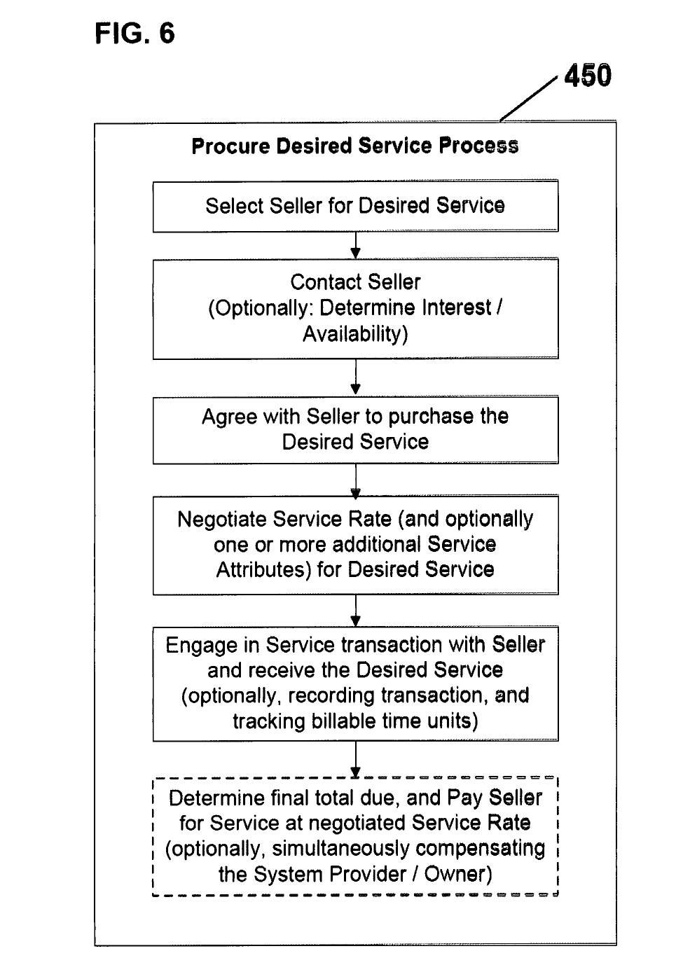

The systems and methods generally comprise a core process (shown by way of example as process 450 in FIG. 6, and shown implemented as a system 16 in FIG. 1, below). Such process may be implemented in one or more data processing systems, which enables a party seeking to receive a desired service, and a party offering to provide the desired service, to readily and easily negotiate one or more terms or aspects of the service procurement and/or provision terms and conditions. Non-limiting examples of such terms of service include cost (and whether such cost will be calculated on a per unit time basis, flat-rate basis, task-based, or result-based (e.g., attorney contingency fee)), service provision location, timeliness, quality of service, project-based milestones (and the fees, if any, associated with the completion of each milestone) and/or experience/skill of the actual service provider, if different from the Seller (e.g., if the Seller has another party (such as an employee or contractor) actually providing the service). Preferably, the core process also includes a pre-configured and pre-arranged payment module that enables payment for a performed service to be quickly determined and made to the Seller (optionally with a fee going to the party responsible for operating or enabling the process), after the service is rendered. In addition, the invention provides that such payment will preferably be made within and facilitated by an online payment system that is accessible within the data processing system, which may facilitate a payment using, for example, a credit card, debit card, or bank account transfer.

As used herein, the phrase “the party responsible for operating or enabling the process,” and similar phrases and terms related to such parties, refers to a party that operates, owns, manages, and/or controls a system that may be used to carryout the methods described herein. For example, the invention provides that a party may operate, own, manage, and/or control a website in which (i) Buyers may search for and negotiate with Sellers, (ii) Buyers and Sellers may commence a service session, (iii) Buyers and Sellers may access a tool for monitoring the duration of a service session, (iv) the total fees owed by a Buyer to a Seller may be calculated, and/or (v) a Buyer may submit payment to a Seller in exchange for the provision of services. The phrase “monitoring the duration of a service session,” and similar phrases used herein, encompasses the ability of such tool to not only monitor the duration of a service session, but also to (a) record and present the duration of a service session to a Buyer and/or Seller, (b) calculate and present the total fees owed by a Buyer to a Seller, and/or (c) the other controls and features described herein, such as the ability to reversibly pause the monitoring and recording of a service session.

Advantageously, the methods of the present invention may be carried out with the Buyer and Seller each using the same, similar, or different data processing and/or communication systems. For example, the Buyer may be utilizing a mobile smart phone, while the Seller may be using a conventional personal computer. In addition, because the core process of the present invention relates to, among other things, the negotiation of service procurement/provision terms and conditions (and possibly payment for rendered service), it is platform-, environment-, and domain-independent, and can therefore be used with any type of service. Non-limiting examples of such services include, but are not limited to, the provision of professional advice (legal, medical, technical, accounting, fitness, etc.), technical support, counseling (psychological, fashion, dating, etc.), and/or instruction (language, music, cooking, video game skills, tutoring, art, etc.). In addition, such services may include the provision of physical labor, such as home, automobile, and/or equipment repair, cleaning, transporting, creating a commissioned work, programming, and others. Still further, such services may include the provision of conventional and/or adult entertainment services (subject to applicable laws and regulations). The invention further provides that such service may include certain non-replenishable services, such as video chats with celebrities.

In addition, the systems and methods of the present invention are compatible with and may employ any communication device or method, such as a telephone (including a cellular phone, a smart phone, a VoIP phone, and similar devices), a data processing device (e.g., a personal computer or PDA that is equipped with or able to utilize instant messaging (IM), e-mail, VoIP, Internet chat rooms, Internet work space, or other communication capabilities), facsimile, regular mail, A/V links (videoconferencing, videochat), and in-person communications. For the avoidance of doubt, the term “communication device,” and similar terms, includes in-person communications, i.e., communications between a Seller and Buyer which do not require any particular hardware, software, electronic devices, and the like, or any other mode of communication (e.g., text, voice or video) over any type of communications network and using any communication protocol.

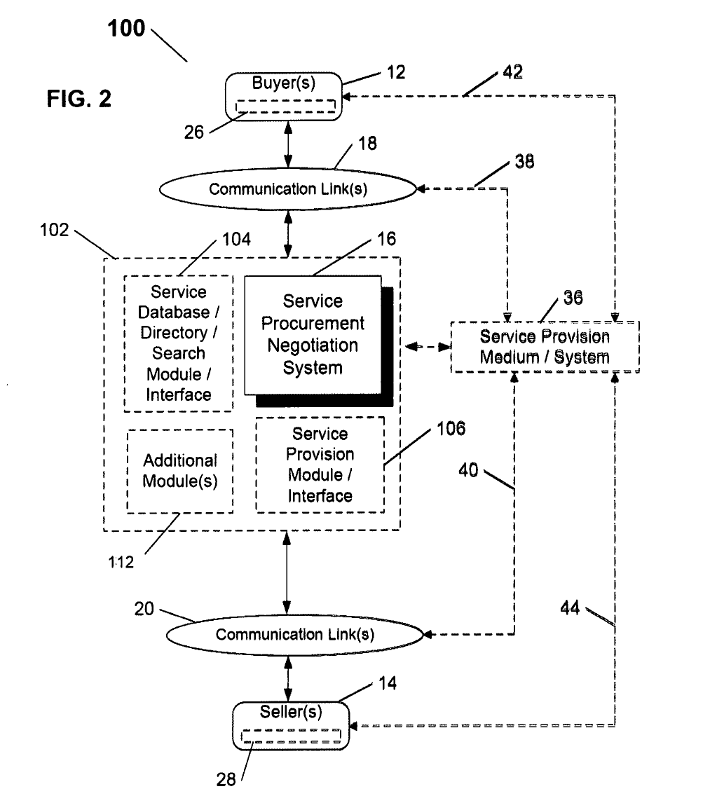

In view of the flexibility and platform-independent modular nature of the core process, rather than being utilized as an independent service terms negotiation and payment tool (as shown in FIGS. 1 and 6), it may be implemented as a more robust comprehensive system, with one or more additional advantageous features, shown by way of example as a system 102 of FIG. 2, and mentioned above and discussed below in connection therewith.

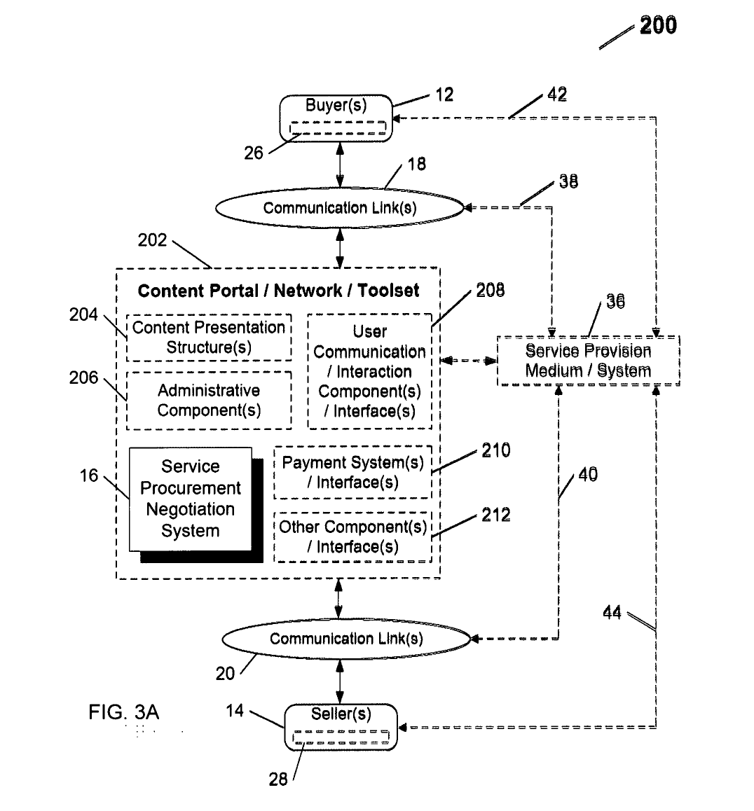

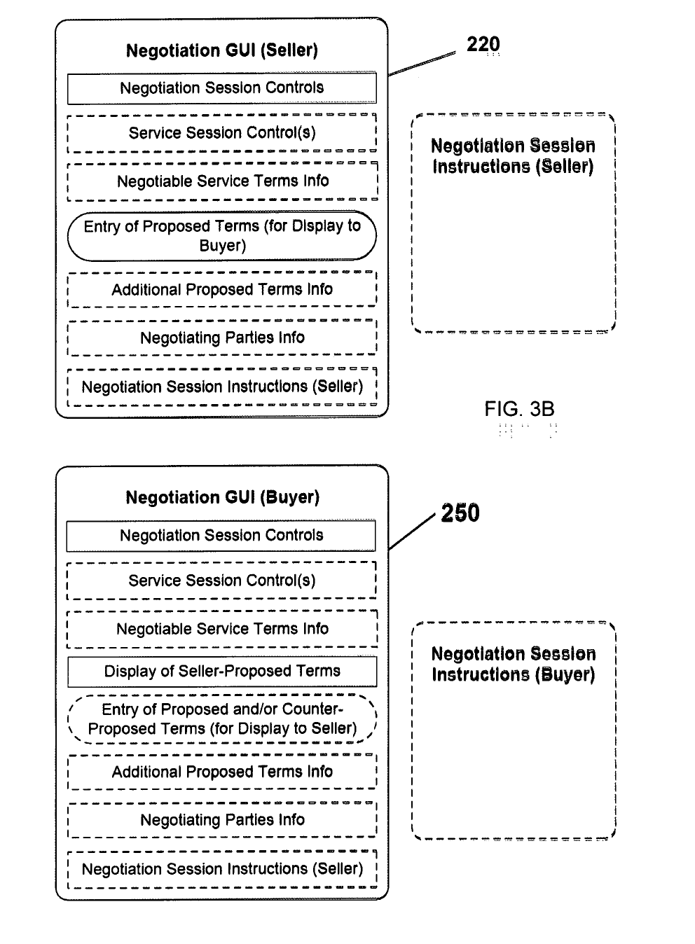

Moreover, the systems and methods embodied in the core process may be readily utilized to add features to a third party system (such as a content portal) already equipped with certain features (e.g., inter party communication capabilities, service directories, payment system, etc.). This is shown by way of example in FIG. 3A, with the core process being implemented in a service procurement negotiation system 16 integrated into a Content Portal/Network/Toolset 202.

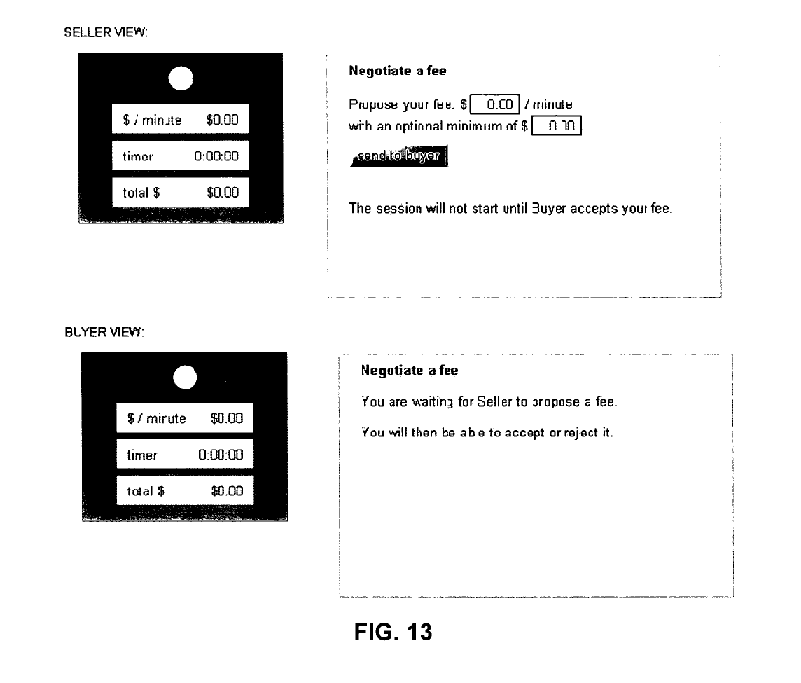

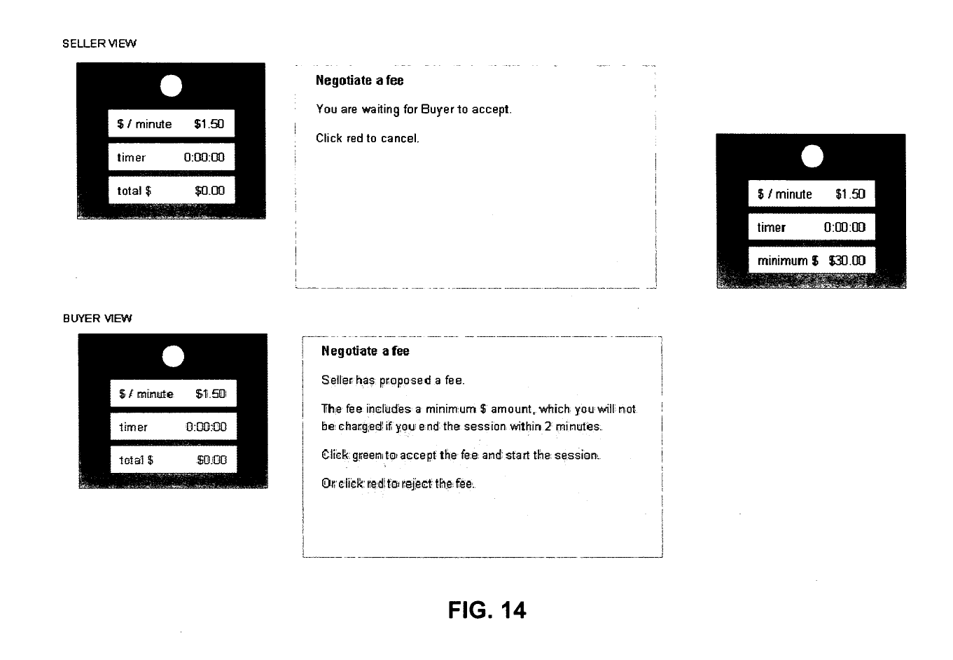

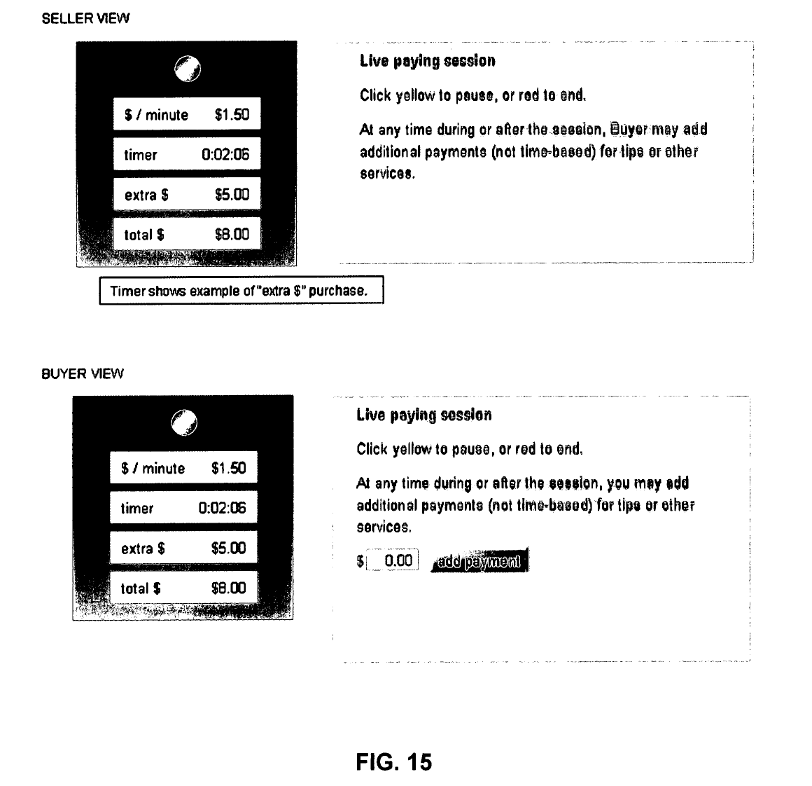

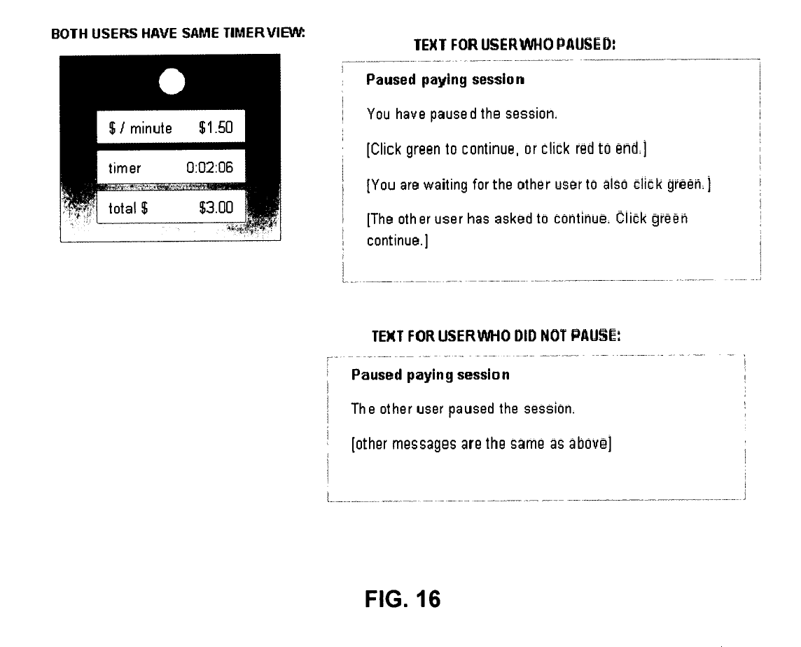

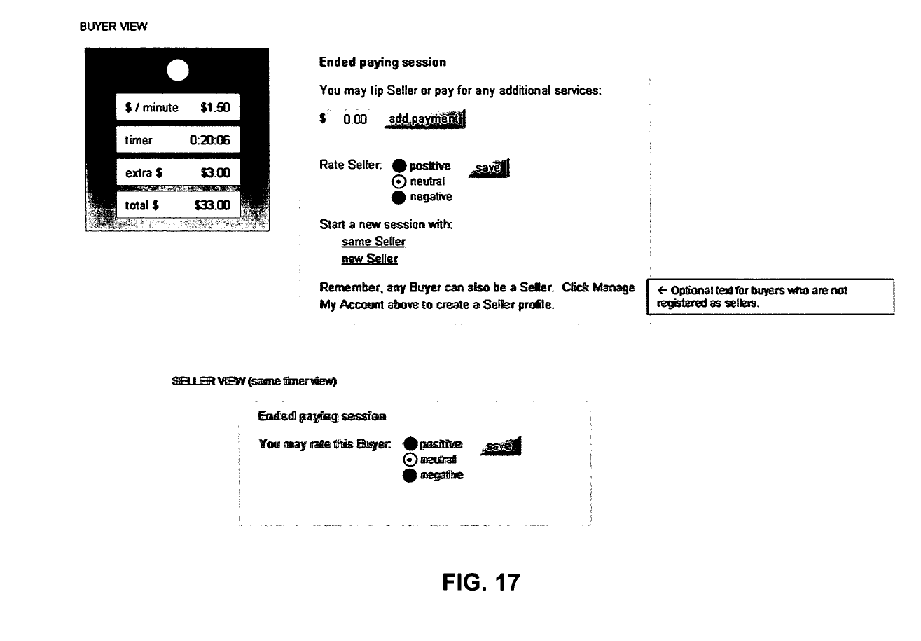

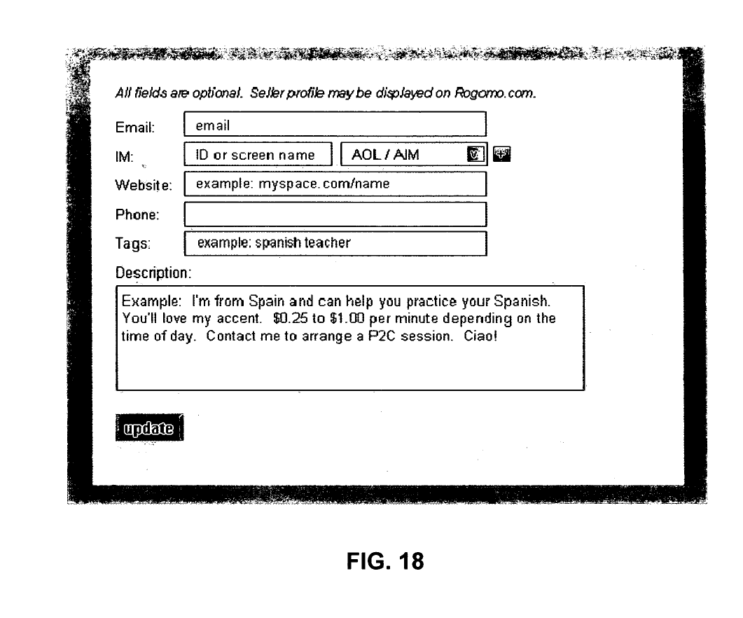

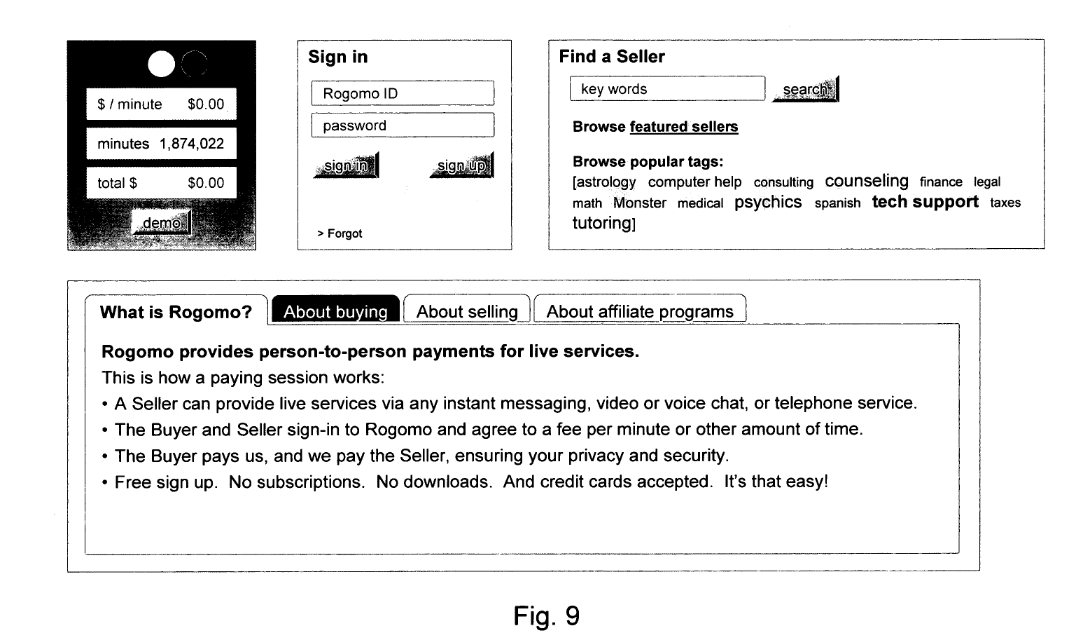

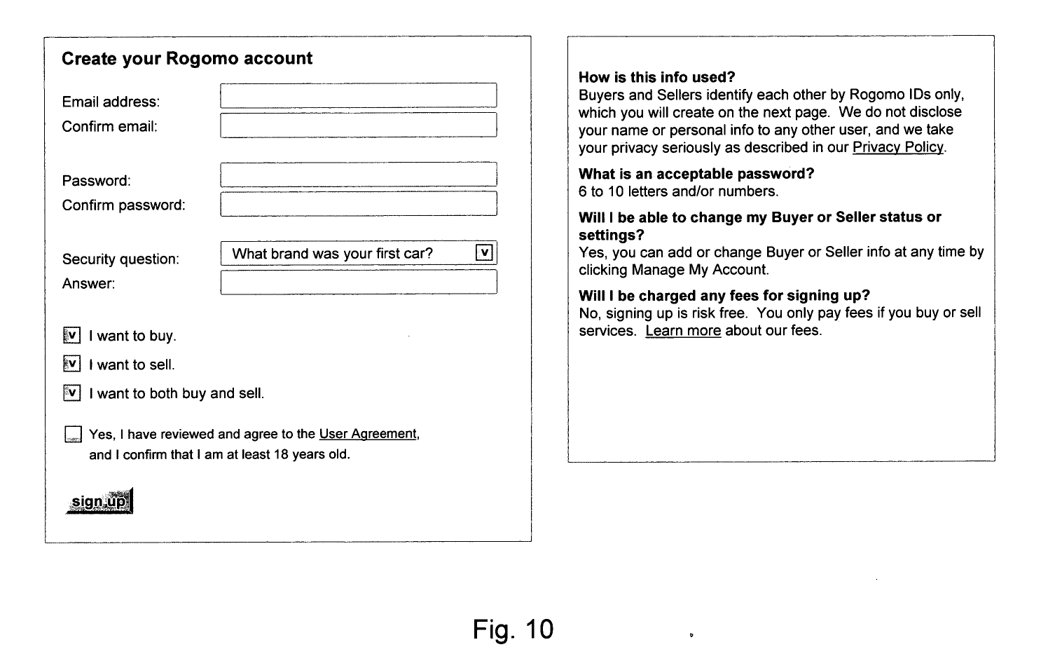

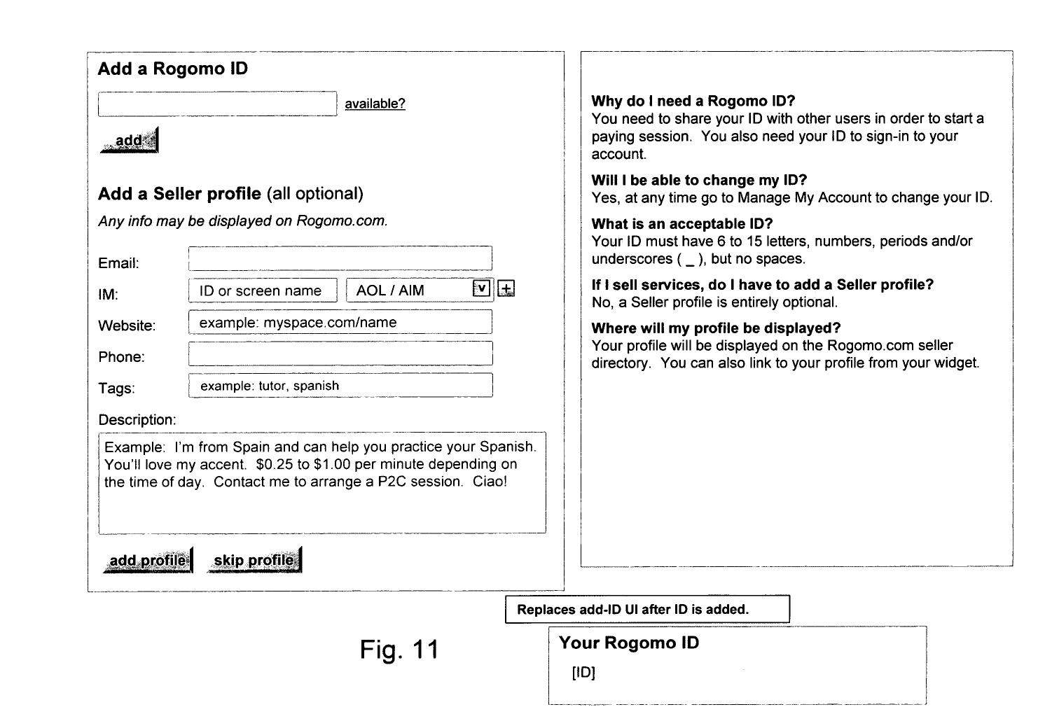

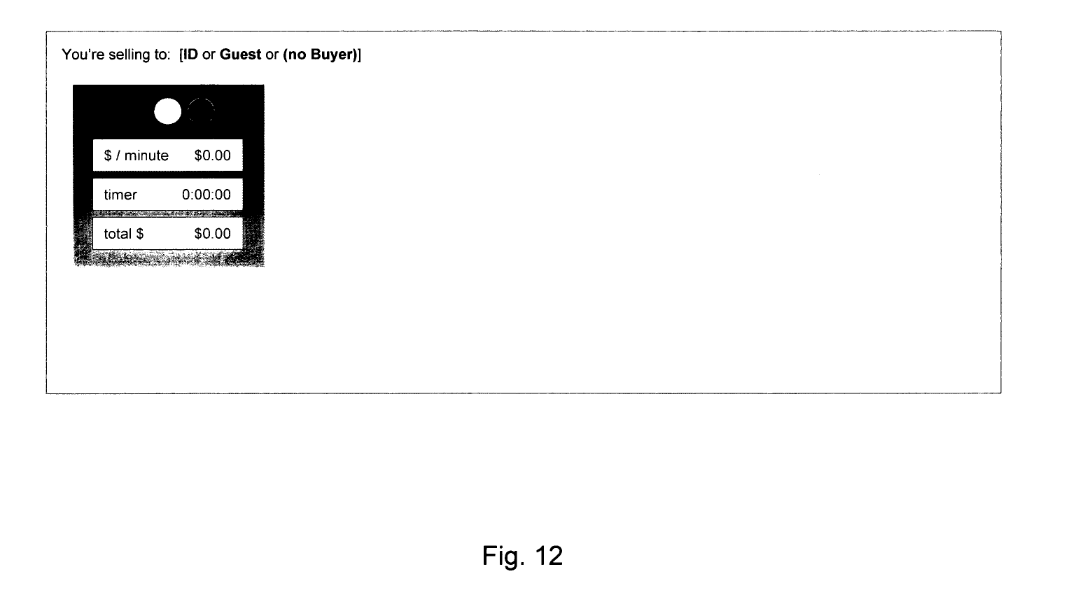

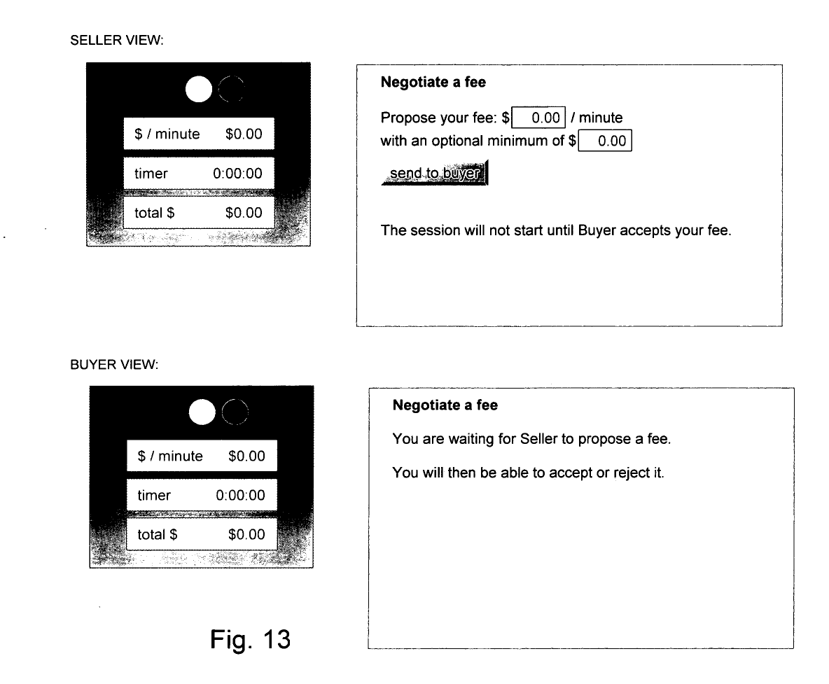

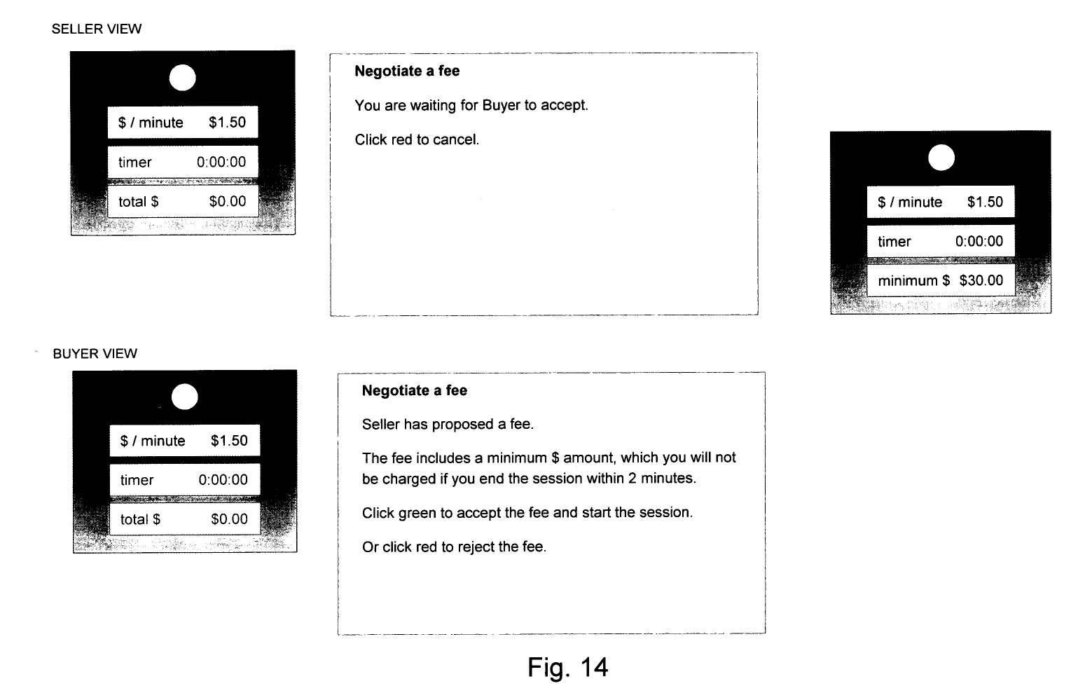

Regardless of the format and/or medium for the eventual provision of a desired service session between the parties, the Buyer and Seller are preferably each provided with a graphical user interface (GUI) for their communication-capable system to enable a dynamic and rapid real-time negotiation session to negotiate one or more terms of the desired service provision therebetween. Exemplary embodiments of such GUIs are shown as Negotiation GUIs 220 and 250 in FIG. 3B, as well as in FIGS. 13 and 14 (and described in greater detail below in connection therewith).

It should be noted that the present invention is described with reference to the Internet, “online” activities, online networks, and “websites” by way of example only and for the sake of convenience and clarity. As a matter of design choice, and without departing from the spirit of the present invention, the various exemplary embodiments of the systems and methods of the present invention can be readily implemented in any environment where users (i.e., Buyers and Sellers) may access it, and interact therewith, and with one another.

Similarly, while the descriptions of various embodiments of the systems and methods of the present invention interchangeably refer to various data processing systems used in conjunction therewith as “computers,” it should be noted that any system with similar capabilities necessary for performing the tasks required by the systems and methods described herein (such as any system having a microprocessor), may readily be used as a matter of necessity or design choice, without departing from the spirit of the invention.

Because the terminology used to describe the various embodiments of the systems and methods of the present invention (and the functionality thereof) evolves and changes rapidly, for the purposes of clarity, and without departing from the spirit of the invention, the various elements, components, infrastructures, and process steps of the such systems and methods are described herein based on their required, expected, and/or desired functionality, and/or in terms of objectives that they are intended to accomplish in accordance with the present invention, rather than as specific structural and process implementations (which may change with advances in information systems technology). For example, as computers of various types are well-known in the art, it is presumed that any computer used in conjunction with the present invention will include the typical components necessary for its operation, e.g., one or more CPUs, memory, long-term data storage, and, in cases of computers that may be utilized by Buyers and Sellers, one or more input devices, a display, and so on.

Referring now to FIG. 1, a first exemplary embodiment of a service procurement/provision system 10 is shown, implementing only a portion of the features of the present invention in a service procurement negotiation (SPN) system 16, which may be implemented, in whole or in part, in one or more data processing systems (such as personal computer, conventional telephone, cellular telephone, smart phone, personal digital assistant (PDA), computerized kiosk, a VoIP phone, a digital media device, or the like), supplied with appropriate application programs to perform the necessary tasks (for example, to perform various steps of the process 450 of FIG. 6, where dashed lines indicate optional elements).

The system 10 is essentially utilized by at least one Buyer 12 and at least one Seller 14, which may communicate with one another through communication links 18, 20, going through the SPN system 16 (and/or optionally through a communication link 22 therebetween), and, optionally, directly through a communication link 24 (including, but not limited to, in-person communications). The various communication links may all be part of one or more related telecommunication networks, or they may be different from one another in whole or in part. A communication link is, preferably, any form of a communication connection between the various components and users of the system 10, which enables data transmission therebetween. Thus, the communication link may each include one or more of the following, in any combination: direct telecommunication line(s), wireless broadband link(s) (e.g., satellite uplink, radio, cellular, wi-fi, etc.), and communication network(s) (such as a LAN (local area network), a WAN (wide area network), the Internet, or an in-person meeting).

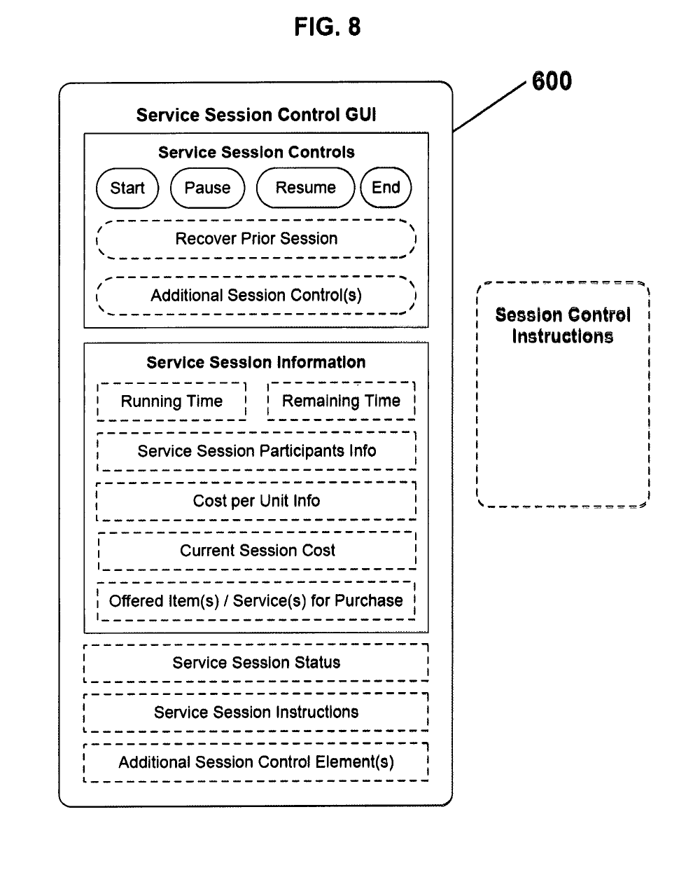

Optionally, one or both of the Buyer 12 and Seller 14 may have a corresponding communication and/or data processing device 26, 28, respectively, for communicating with one another and/or with the SPN system 16 via one or more of the communication links. In such cases, the communication links are preferably capable of displaying appropriate interactive GUIs to the user, such as the Negotiation GUIs 220, 250 of FIG. 3B, the Service Session Control GUI 600 of FIG. 8, and the GUIs shown in FIGS. 13 and 14 (which illustrate yet further examples of GUIs which embody the methods, systems, and components thereof described herein). The GUIs are preferably designed to allow Buyers and Sellers to negotiate at least one term pursuant to which services will be rendered, such as the fees that will be charged by the Seller in exchange for services rendered.

While the terms “Buyer” and “Seller” are generally used herein in a singular fashion, it should be noted that one or more Buyers, and one or more Sellers, can readily simultaneously utilize the novel SPN system 16, limited only by the necessary data processing and communication capabilities thereof, which may readily be made scalable as a matter of design choice without departing from the spirit of the invention. In addition, rather than being an individual, each of the Buyer 12 and/or the Seller 14 may be a group of individuals (such as a business, social, professional, government, religious, or other form of organization). Thus, for example, a law firm with several attorneys can act as a Seller 14, with individual attorneys offering services under the firm's control.

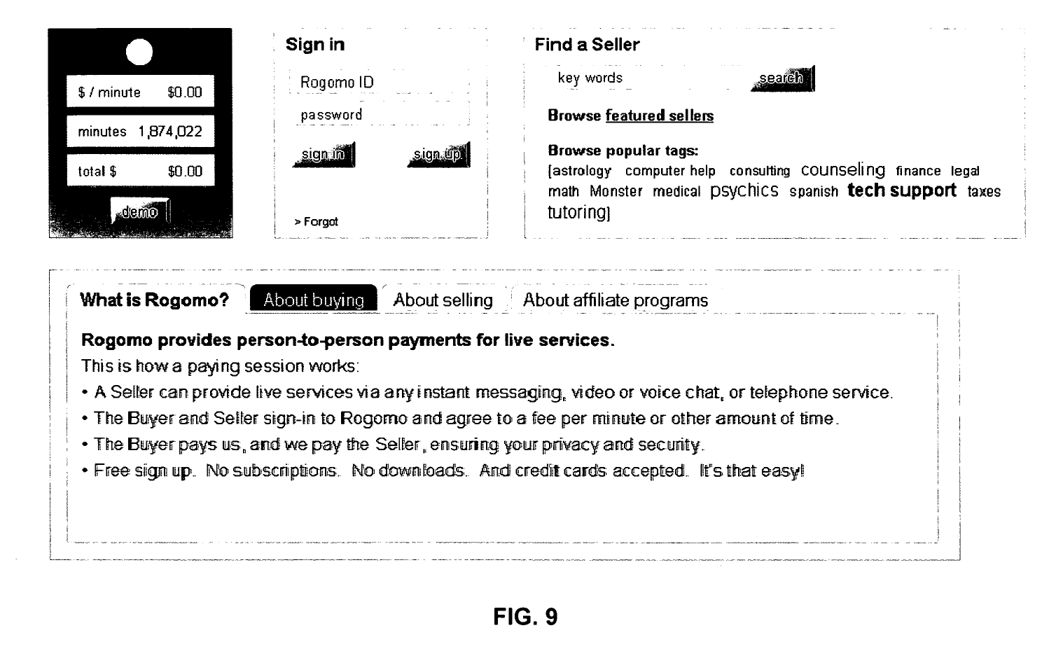

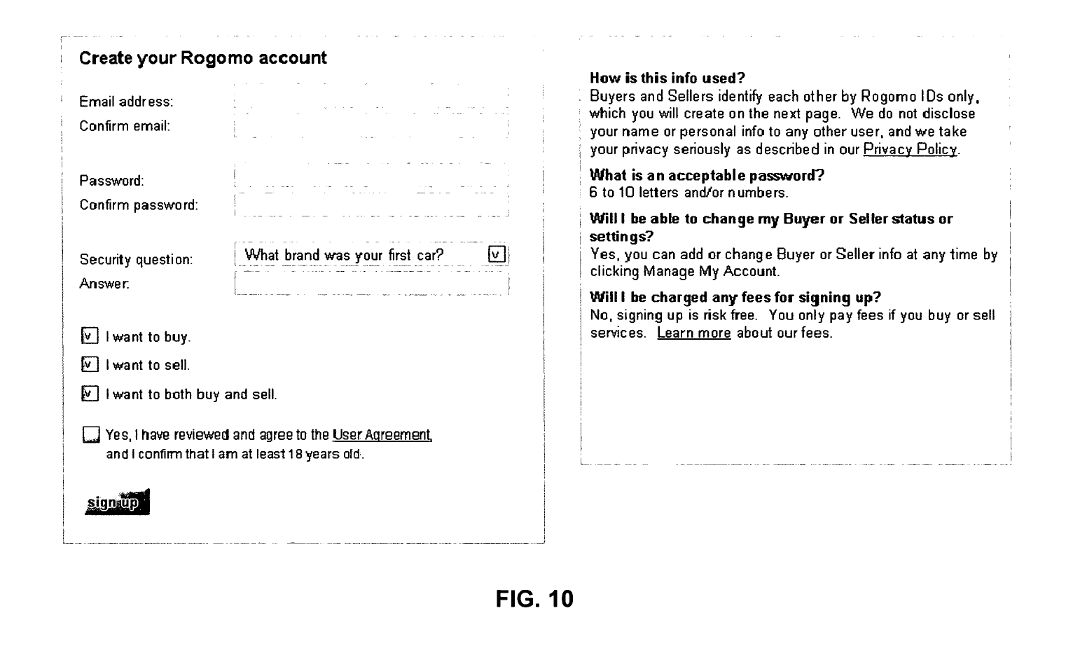

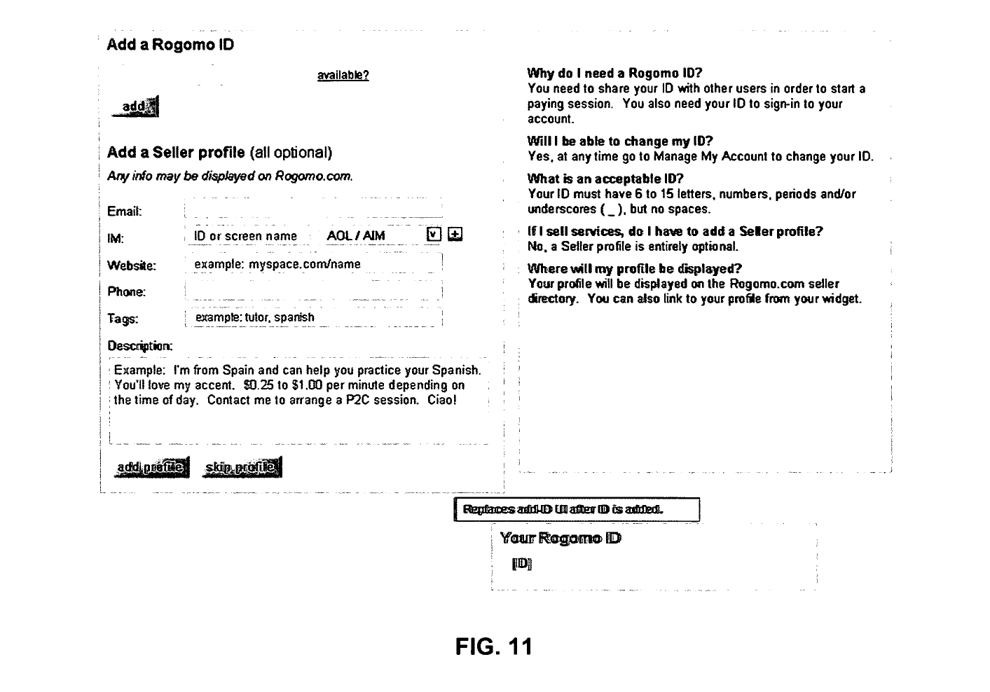

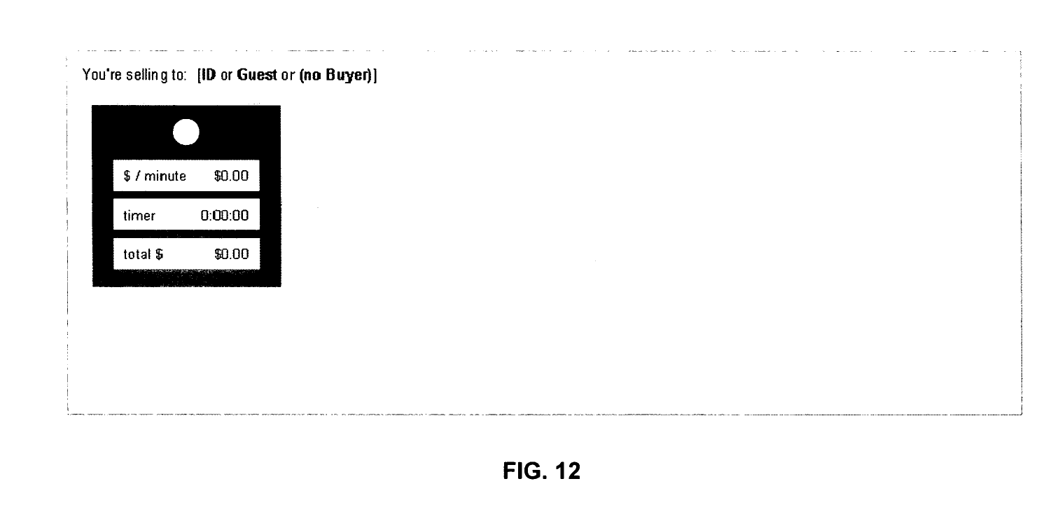

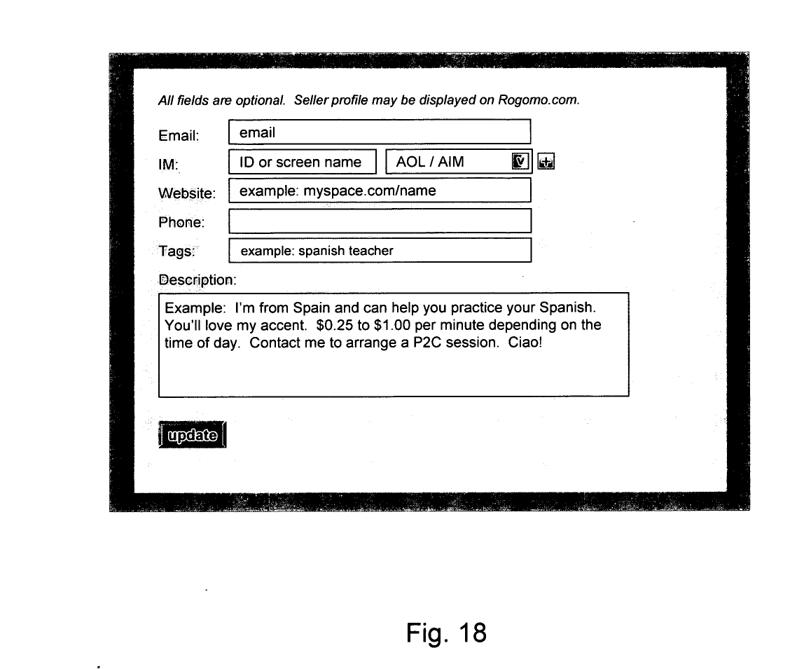

The SPN system 16 is preferably configured to enable the Buyer 12 and the Seller 14 to negotiate one or more terms of a service desired by the Buyer 12, and offered by the Seller 14, such as payment terms, format, schedule, and/or other above-described terms. To facilitate and enhance its utilization, the SPN system 16 preferably includes a registration/login feature 30 that enables users (i.e., Buyer 12 and Seller 14) to: (1) initially provide a number of information items to the SPN system 16, such as identifying information, payment information, and, for the Seller 14, information about the service(s) offered by the Seller 14 (and, optionally, about the Seller 14 and background and qualifications thereof)(See also FIGS. 9-11 and 18), and (2) upon completion of registration, to log into the SPN system 16, so that the SPN system 16 may be utilized, and appropriate records retrieved (See also FIG. 9). Optionally, the SPN system 16 may include a “retainer” (also referred to herein as a “deposit account”) feature that enables users intending to purchase services to pre-pay a certain amount, such that purchased services are readily charged against the “retainer” (or deposit account), without the user having to execute a separate payment transaction for each purchased service.

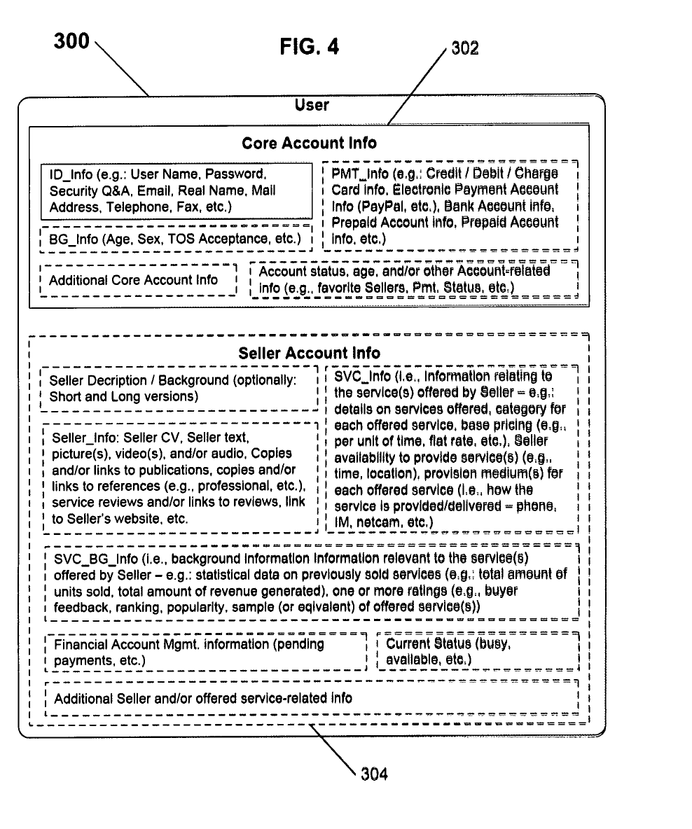

Referring now to FIG. 4, an exemplary user record 300 is shown (with dashed lines indicating optional elements), which may be acquired and stored by the SPN system 16 during registration and thereafter. The user record 300 includes a core account information portion 302, completed by both the Buyer 12 and Seller 14, and a seller account information section 304, completed by the Seller 14. Optionally, the user record 300 may include support for multiple user names linked to the same account, so that the Buyer 12 and/or the Seller 14 may separate purchase and/or provision of different types of services (e.g., business, educational, personal improvement, adult entertainment, etc.) without having to establish and manage separate accounts.

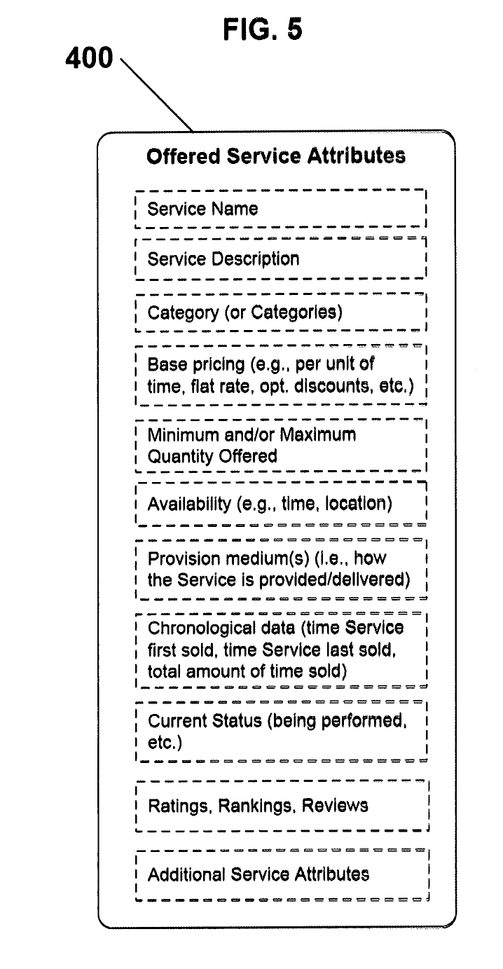

Once the Seller 14 identifies one or more services that it offers and provides information relevant thereto (such as, for example, by creating a Seller profile/listing within a comprehensive Seller directory, as described further below), the SPN system 16 may store the offered service attributes in a record (for example, such as an offered service attributes record 400 of FIG. 5). This approach is especially useful in more feature-rich embodiments of the systems and methods of the present invention (such as shown in FIGS. 2 and 3). The Seller 14 may also provide a schedule of times for offered services, optionally, along with other service-related information, which would be made available to interested Buyers. With respect to a schedule of times for offered services, in certain embodiments, a Seller may be allowed to prescribe different fees based on whether a service session is carried out during normal business hours, or anytime after or before normal business hours. For example, the invention provides that a Seller may be allowed to identify (i) preferred hours of availability (which may be associated with a standard fee rate) and (ii) less preferred hours of availability (which may be associated with a premium fee rate).

In accordance with the present invention, the offered services may advantageously be configured with a number of additional and/or optional features, terms of provision, and provision protocols. Non-limiting examples of such features include the means for selecting different pricing structures for the same (or similar) service, with variations from base price being dependent on one or more terms of the service provision (e.g., the medium in which the service is delivered (e.g., text chat, telephone, video chat, etc.), timing of service delivery (e.g., immediately, next day, in a week, etc.), and/or the duration of the service (e.g., a lower price for longer service provision session, etc.)). Additional examples of such features include the means for enabling multiple buyers to pool resources to purchase services (e.g., as a group session), with additional supporting features, such as providing to the Buyers an indicator of the current status of resource pool, and remaining resources that must be secured to enable provision of the service. For such services, negotiation can take place before resources are pooled (for example by one of the Buyers, such as the Buyer who initiated the pool), or after several Buyers have pooled resources together that are lower than the Seller's set price for the service.

The present invention further provides that certain services (e.g., premium services), may be auctioned within a predetermined auction format, in lieu of negotiation. Furthermore, the invention provides that multiple users of the systems and methods described herein, in certain embodiments, will have the ability to negotiate for cross-provision of services, i.e., bartering their services to one another. Still further, the invention provides that prospective Buyers may post a project within a centralized website, for example, whereupon Sellers may subsequently submit (confidential or non-confidential) bids to perform the project for the Buyer. For example, a Buyer may desire 15 minutes of instruction regarding how to install software into a certain device. In such case, the Buyer may publish a description of the instruction/advice that is desires within a centralized website, whereupon Sellers may then submit (confidential or non-confidential) bids/offers to render such instruction. Such bids/offers may set forth one or more terms pursuant to which the requested instruction/advice will be rendered by each service provider, such as the cost, duration, and timeliness thereof. Upon receiving bids from a plurality of Sellers, the Buyer may then select the desired service provider.

In addition, in certain embodiments of the invention, the systems employ GUIs that expose Buyers and/or Sellers to advertising content during service provision and, optionally, enabling elimination of the content upon payment of an additional fee to the party enabling the service provision infrastructure. In other embodiments, the systems and methods enable the Seller to share in advertising revenue, or enable the Buyer to reduce the fee paid for the service by accepting the presence of advertising. Optionally, the advertising may be contextual (e.g., relevant to the service being rendered) or non-contextual.

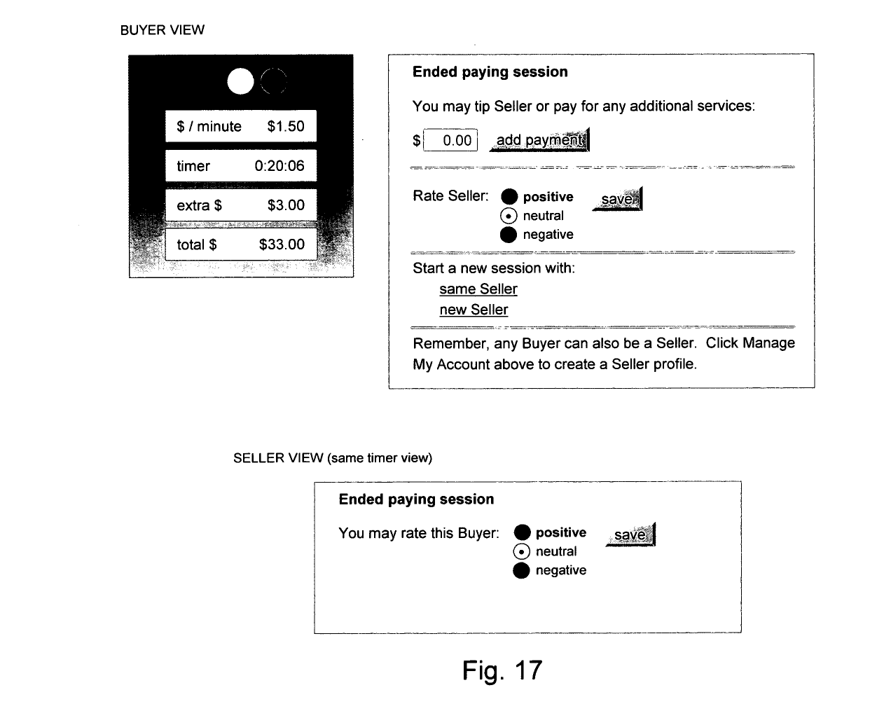

According to yet additional embodiments, the systems and methods described herein may offer certain products and/or other services to the Buyer 12 during the provision of a service (e.g., by the Seller 14, or otherwise), thereby allowing the Buyer 12 to easily purchase the offered good or additional service, either during service provision session or at the conclusion of the session. Optionally, a portion of the purchase price is paid to the party enabling the provision of the service. The invention may further allow a Buyer 12 to provide the Seller 14 with a bonus payment either at its own initiative, or at the request of the Seller 14, which is illustrated by way of example in FIG. 17. For example, if a Buyer is particularly satisfied with the quality of services rendered by a Seller, in certain embodiments, the invention allows the Buyer to submit a “tip” to the applicable Seller.

The SPN system 16 may include a negotiation module/interface 32, which enables the Buyer 12 and Seller 14 to readily conduct local or remote real-time negotiations over certain terms of the desired service, such as the format, medium of delivery, schedule, and compensation. For example, negotiation module/interface 32 may display sequential offers and counteroffers to each party, until one party accepts or cancels the transaction. Optionally, after a successful negotiation, if the service is not going to be provided immediately, the parties may be given an opportunity to schedule the provision of the service.

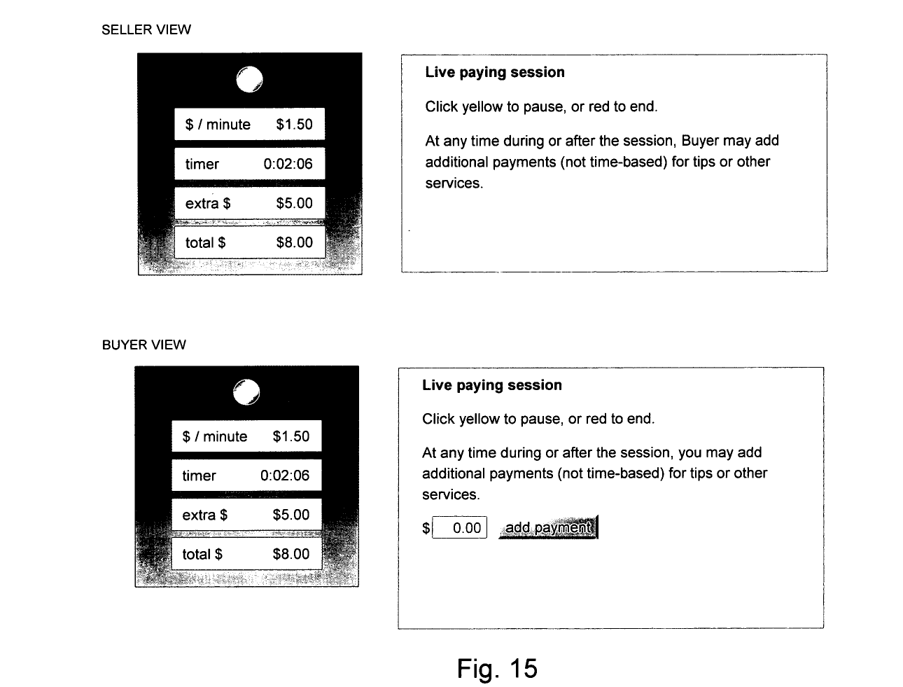

Referring now to FIG. 3B, exemplary embodiments of a Negotiation GUI 220 provided to the Buyer 250, and a Negotiation GUI 220 provided to the Seller 14, utilizing corresponding respective communication-capable devices 26, 28, are shown (with elements having dashed lines being optional). The Negotiation GUIs 220, 250 provide the Buyer 12 and the Seller 14 with the ability to quickly negotiate one or more terms of the desired service provision in real-time, such as, but not limited, the fees that the Seller will charge in exchange for the Services. Optionally, the Negotiation GUIs 220, 250 are provided with service session controls operable to immediately begin a service provision session upon completion of a successful negotiation session, whereupon the Negotiation GUIs 220, 250 are replaced by the Service Session Control GUI 600 for each party. See also FIGS. 14 and 15, respectively. In addition, negotiation session instructions may be provided as part of each respective Negotiation GUI 220, 250, or optionally as separate graphical elements which may be context-sensitive.

In one embodiment of a negotiation session in which the Negotiation GUIs 220, 250 are utilized, Seller 14 may use the GUI 220 to enter at least one proposed term (such as a fee charged for the service per unit of time) for display to the Buyer 12 on the GUI 250. This feature is also illustrated in the GUI shown in FIG. 13. The Buyer may then either accept or decline the offer, whereupon the Seller 14 may end the negotiation session, or provide the Buyer with another offer. This step and feature is further illustrated in the GUI shown in FIG. 14. Optionally, the Buyer 12 may be provided with the ability to enter and transmit a counteroffer to the Seller 14, which the Seller 14 may in turn accept, decline, or counter. Alternately, the Buyer 12 may be the party that initiates the negotiation session by making an initial offer of at least one term to the Seller 14. Other novel features of the Negotiation GUIs 220, 250 are shown in FIG. 3B. FIG. 15 illustrates a non-limiting example of a GUI showing an active service session, following the acceptance of both the Buyer 12 and the Seller 14 of the negotiated term(s).

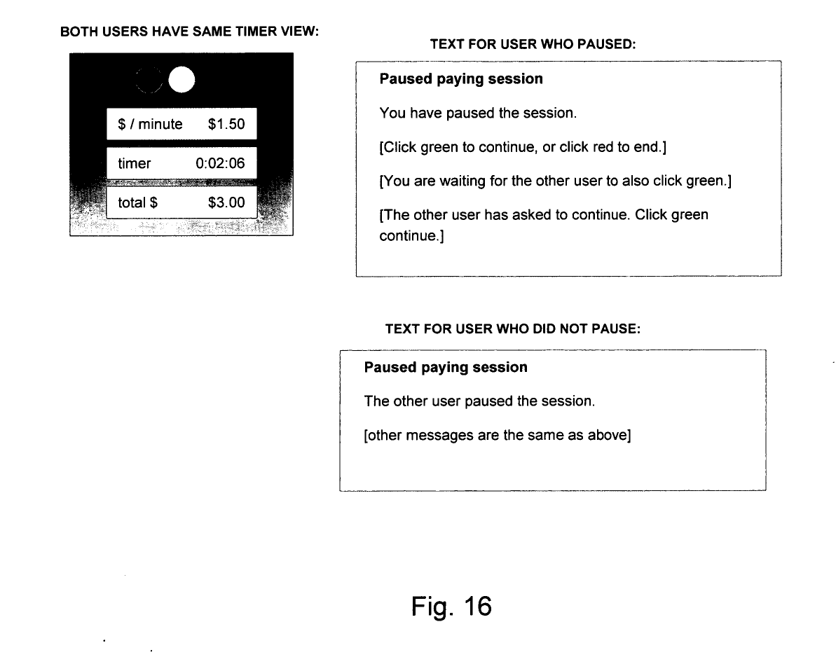

The SPN system 16 may optionally include a service monitor module 34, to monitor and record the duration of performance of the service (e.g., to keep a running time/money total) and to possibly enable one or both parties to suspend and resume the service. The service monitor module 34 is also referred to herein as the “tool,” which may be capable of, among other things, monitoring and displaying the duration of a service session, calculating and displaying the fees owed by a Buyer to a Seller in real-time, and providing controls that enable a Seller and Buyer to reversibly pause the step of monitoring the duration of a service session. Such features are also illustrated in the GUIs shown in FIGS. 15 and 16, whereby the service session is shown to be paused in FIG. 16.

Importantly, in certain preferred embodiments of the invention, the “tool” (or service monitor module 34) begins to record the duration of a service session only upon receiving instructions to do so by the Seller and/or Buyer. That is, in certain embodiments of the invention, the “tool” (or service monitor module 34) is not triggered to begin recording the duration of the service by the mere establishment of a communication link between the Seller and Buyer. Rather, the Seller and/or Buyer must affirmatively instruct the “tool” (or service monitor module 34) to begin recording the duration of the service session.

Still further, the invention provides that the “tool” (or service monitor module 34) will automatically pause (or terminate) the recordation of the duration of a service session upon a disruption to the connection link between the Seller and Buyer. For example, in the event that a communication link/signal is broken between the Seller and Buyer, such that the Seller and Buyer may no longer communicate to one another, the “tool” (or service monitor module 34) will detect such disruption to the communication link and automatically pause (or terminate) the recordation of the duration of the service session.

Optionally, a Seller 14 may designate a third party as the recipient of payment for their services, e.g., to a seller organization of which the Seller 14 is a member, to a charity, etc. Still further, the invention provides that the Buyer 12 may initially make payment to an escrow agent, whereby the funds deposited with the escrow agent are released by the Buyer 12 upon completion of the services (or upon completion of the services to the Buyer's 12 satisfaction). Depending on the nature of the purchased service, it may either be provided through the SPN system 16, or it may be provided using a separate service provision system 36 in the same or another medium (e.g., online, over a telephone, in person, etc.).

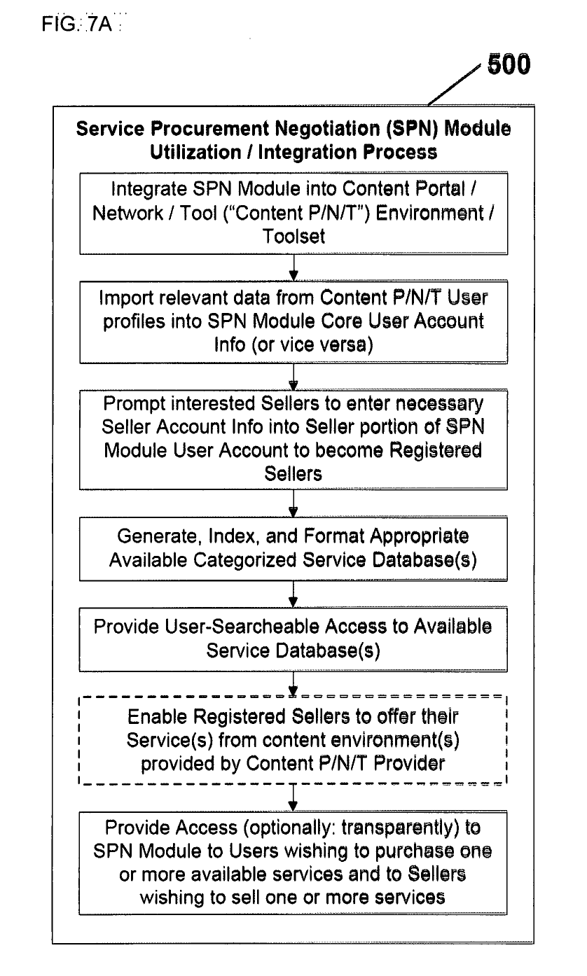

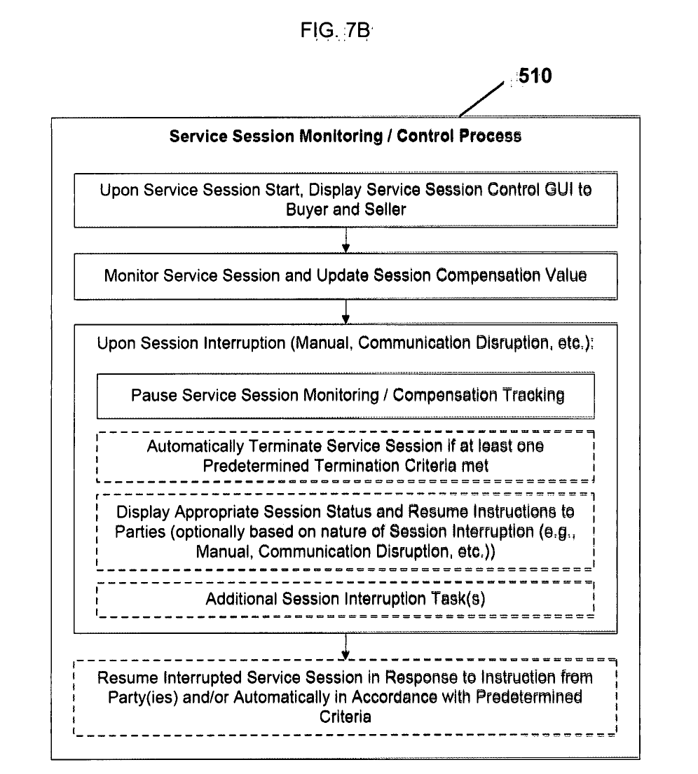

Referring now to FIG. 8, the service monitor module 34 may be accessed and controlled via the Service Session Control GUI 600, regardless of the medium of the actual service session provision. More specifically, the Service Session Control GUI 600 may provide, among other things, (1) service session controls enabling the parties to start, pause, resume, and/or end the session, recover a prior session, or perform other session control tasks; (2) Service Session Information, for displaying various session-related information to the participating parties; (3) Service Session Status, showing the current status of the session (e.g., in progress, paused, ended, etc.); (4) Service Session Instructions, either as part of the GUI 600 or as a separate graphical element, in each case optionally being context-sensitive; Additional Session Control Elements; and/or any combination of the foregoing. FIG. 7B further shows an exemplary Service Session Monitoring/Control Process 510 for utilizing the service monitor module 34.

Preferably, the SPN system 16 also includes a payment module 46 for enabling the Buyer 12 to pay the Seller 14 for provision of the purchased service, and to optionally pay a fee to the owner/operator of the SPN system 16. Optionally, a Seller 14 may designate a third party as the recipient of payment for their services (e.g., to a seller organization (e.g., a charity) of which the Seller 14 is a member or to an escrow agent).

Depending on the nature of the purchased service, it may either be provided through the SPN system 16, or it may be provided using a separate service provision system 36 in the same or another medium (e.g., online, over a telephone, in-person, etc.).

Referring now to FIG. 2, a comprehensive compensated service procurement/provision system 100 is shown as a second exemplary embodiment of the systems and methods described herein, which may be implemented, in one or more data processing systems, as a service system 102, and which includes all the features of the system 10 of FIG. 1, and also includes at least one of the following features. (1) service database/directory & search module/interface 104 as described further below (e.g., providing a browsable and searchable directory of all offered services with information from Seller account information 304 of FIG. 4 (i.e., Seller profiles and listings) and offered service attribute record 400 of FIG. 5 (for each service); (2) a service provision module/interface 106—for providing one or more suitable (and optionally optimized) interfaces for remote service provision, such as videoconferencing, private chatrooms, VoIP channels, etc.; (3) a service monitor/control module interface 106—for enabling dynamic monitoring and control of the service provision session (e.g., as shown by the exemplary process 500 of FIG. 7A, utilizing the Service Session Control GUI 600 of FIG. 8); and (4) additional module(s) 112, which may comprise any other components useful to the service system 102.

By way of example, one exemplary implementation of the service system 102 would be as a modular (and, optionally, independent) website that provides all necessary tools for procurement, negotiation, provision of services and payment therefor.

Referring now to FIG. 3A, a comprehensive compensated service procurement/provision system 200 is shown as a third exemplary embodiment of the systems and methods described herein, with the SPN system 16 being integrated as a component of a content portal, network, or toolset 202. The service procurement/provision system 200 preferably includes all the features of the system 10 of FIG. 1, and, optionally, one or more features of the system 100 of FIG. 2. Preferably, this may be advantageously and readily accomplished by interfacing the novel SPN system 16 with one or more of the existing components 204 to 212 of the Content Portal 202, which may be implemented in infrastructure layers, software applications, and/or middleware systems thereof. Referring now to FIG. 7A, an exemplary process 500 for integrating the SPN system 16 into the Content Portal 202 as a module is shown, with dashed lines indicating optional elements/steps.

As described above, the invention provides that a service database/directory (and corresponding search module/interface 104) may be used to compile listings of and information regarding Sellers. Such directories may include all types of content, including basic text, images, audio, and/or video content related to a particular Seller. In certain embodiments, the plurality of Seller listings that comprise such directories are presented in a substantially standardized format (as described further below).

The plurality of independent Seller profiles/listings are, preferably, accessible within one, two, or limited number of websites comprising (or associated with) one or more online directories or sub-directories. In addition, the invention provides that such online directories described herein may be “hosted” within a centralized server (or group of networked servers). By centralizing the location of the Seller profiles/listings, prospective Buyers will have a well-known and established location to search for qualified Sellers for a particular service.

In certain embodiments, the invention provides Sellers with an option of registering a standard listing and/or an enhanced listing. The standard listing may be, for example, offered free of charge or, alternatively, at a lesser fee than the enhanced listing. In such embodiments, the enhanced listing may allow Sellers to incorporate certain media types into a profile (or listing), which may not otherwise be used within a standard profile (or listing).

The fees that may be charged to Sellers for publishing a standard and/or enhanced profile, if any, may be issued at defined intervals, such as monthly, quarterly, biannually, or annually. In certain preferred embodiments, however, the fee is charged and collected electronically. The methods of charging and collecting such fees electronically are well-known to those of ordinary skill in the art of electronic-commerce, which may include internet-mediated credit card processing, debit card processing, automated withdrawals from selected bank accounts, and other methods (currently existing and discovered hereafter).

The invention further provides that Sellers which publish a standard and/or enhanced listing within such directories may specify certain “keywords” associated with each listing. Preferably, such “keywords” associated with (and specified for) each listing are considered upon an individual or business (e.g., a prospective Buyer) using the directory to search for certain information. For example, if a Seller offers legal services and describes itself as a law firm in its enhanced or complimentary listing, an appropriate “keyword” may be “legal” or “law.” Thus, upon searching the directory for Sellers that offer legal services (using any of various search logic incorporating either “legal” or “law”), such users are presented with search results that comprise one or more Seller profiles/listings associated with or containing such “keywords.” In certain embodiments of the invention, Sellers may specify one or more “keywords” for a Seller profile, wherein the number of “keyword” specified may be limited or unlimited.

The invention contemplates that the directory may (either in place of or in addition to such Seller-identified keywords) employ its own independent search logic. For purposes of illustration only, upon a user submitting a search using, for example, a keyword function, the directory may query the content of each text field associated with each Seller profile and base search results according to a prioritized inventory of listings which include text fields comprising the literal search terms or derivations thereof. Still further, the directory may produce such user-prompted search results based on a combination of its own search criteria and the Seller-identified “keywords.”

Still further, the directory may require that users narrow the scope of their search using such criteria. For example, before submitting a search, each user may be required to specify the general category of services desired. Alternatively, the users may be provided with the option of narrowing their search, wherein, for example, the category of services function may be used or ignored.

In certain embodiments, such online directory may employ certain technical restrictions on the size, file types, resolution, or other attributes of the one or more digital images, audio files, and/or video files that each Seller may publish within its profile.

It is contemplated that certain users of the internet may not have sufficient, or preferred, software for viewing certain files that are published in the directories used in the methods and systems described herein. Accordingly, the directories may, optionally, provide the software to such users for download. Alternatively, the directory may include a hyperlink to the organization (or other website) where such software may be purchased, downloaded, or otherwise accessed.

In certain embodiments, Sellers may further publish documents that may be downloaded or printed from the directory. In certain embodiments of the present invention, it may be desired to offer such capability to Sellers of enhanced listings only (and not complimentary listings) or, alternatively, to all Sellers. Such documents may be presented in any suitable format, such as in portable document format (PDF) form. In its envisaged that certain Sellers may desire to publish informative (e.g., a resume or curriculum vitae) and/or promotional literature therein.

Preferably, the online directories exhibit a standardized GUI. There are many benefits associated with such standardization. For example, it creates uniformity among the profiles that are published by the various Sellers in the directories. Such uniformity facilitates quick access to and reviews of desired information, while, in light of the potential use of multi-media components of enhanced listings, simultaneously provides an entertaining and informative experience to users, such as prospective Buyers.

It should further be noted that the systems and methods of the present invention are completely language-independent and may thus be applied to, and utilized with, any language.

In addition, while there have been shown and described fundamental features of the invention as applied to preferred embodiments thereof, it will be understood that various omissions and substitutions and changes in the form and details of the systems and methods illustrated and/or described herein, and in their operation, may be made by those of ordinary skill in the art without departing from the spirit of the invention. For example, it is expressly intended that all combinations of those elements and/or method steps which perform substantially the same function in substantially the same way to achieve the same results are within the scope of the invention.

What is claimed is:

1. A method for delivering services, which comprises:
(a) establishing a connection with a client using a communication device that is selected or approved by the client among a plurality of communication device options;
(b) initiating a service session using the communication device; and
(c) monitoring the duration of the service session using a tool that is accessed via a data processing system, wherein said tool is capable of monitoring the duration of the service session which employs any of said communication device options or combinations thereof.

2. The method of claim 1, which further comprises negotiating and agreeing upon at least one term pursuant to which services will be rendered to the client.

3. The method of claim 1, wherein:
(i) the client includes two or more independent parties;
(ii) the services are rendered by two or more independent parties; or
(iii) the client includes two or more independent parties and the services are rendered by two or more independent parties.

4. The method of claim 1, wherein the step of monitoring the duration of the service session is automatically reversibly paused upon a disruption to the connection between the client and a service provider.

5. The method of claim 2, wherein the term is a fee that the client will pay in exchange for the services.

6. The method of claim 5, wherein the fee is (a) calculated on a per unit time basis, (b) a flat-fee arrangement, or (c) any combination thereof.

7. The method of claim 6, wherein the fee is calculated on a per unit time basis, wherein the tool calculates in real-time the fee owed by the client in exchange for the services.

8. The method of claim 5, wherein upon the service session concluding, a total fee owed by the client is calculated and accessible within the data processing system.

9. The method of claim 8, wherein the data processing system is provided with a system that enables the client to submit payment for the total fee owed.

10. The method of claim 9, wherein a portion of the payment that is submitted by the client is retained by or deferred to a third party.

11. The method of claim 9, wherein the total fee owed is deducted from a deposit account maintained by the client.

12. The method of claim 2, wherein the tool is provided with a control that enables the client or a service provider to reversibly pause the step of monitoring the duration of the service session.

13. The method of claim 2, wherein the services are selected from the group consisting of legal services, medical consultations, technical consultations, accounting services, fitness consultations, psychological consultations, fashion consultations, dating consultations, language instructions, musical instructions, cooking instructions, video game consultations, tutoring sessions, art consultations, interior design consultations, computer programming consultations, website design services, home repair consultations, adult entertainment services, and electronic equipment support services.

14. The method of claim 2, wherein the plurality of communication device options comprise telephony, instant messaging, electronic mail, facsimile, regular mail, blogs, chatrooms, videochat connections, videoconferencing, videochat, online collaboration workspace, VoIP, and in-person communications.

15. The method of claim 2, wherein the client selects a service provider from a provider directory, whereby the provider directory comprises a plurality of provider listings which provide information regarding each service provider.

16. The method of claim 2, wherein the tool is accessed within a dedicated website.

17. The method of claim 2, wherein the tool may be accessed and used within a data processing system independent of a website.

18. The method of claim 2, wherein negotiating and agreeing upon at least one term pursuant to which services will be rendered to the client is carried out within a data processing system, wherein the data processing system provides a graphical user interface which provides real-time quotes or bids for fees to be charged in exchange for services.

19. The method of claim 18, wherein the graphical user interface provides controls that allow service providers and clients to submit and adjust said quotes or bids.

20. A method for delivering services, which comprises:
(a) establishing a connection with a client using a communication device that is selected or approved by the client among a plurality of communication device options;
(b) negotiating and agreeing upon a fee that the client will pay in exchange for the services, wherein:
(i) the fee is calculated on a per unit time basis, and
(ii) the step of negotiating and agreeing upon the fee that the client will pay in exchange for the services is carried out within a data processing system that comprises a graphical user interface which provides real-time quotes or bids for fees to be charged in exchange for the services;
(c) initiating a service session using the communication device; and
(d) monitoring a duration of the service session using a tool that is accessed via a data processing system, wherein said tool:
(i) is capable of monitoring the duration of the service session which employs any of said communication device options or combinations thereof,
(ii) calculates the total fees owed by the client in real-time, wherein the total fees owed are presented in a graphical user interface within a data processing system, and
(iii) is provided with a control that enables the client or a service provider to reversibly pause the step of monitoring the duration of the service session.

21. A method for delivering services, which comprises:
(a) establishing a connection with a client using a communication device that is selected or approved by the client among a plurality of communication device options;
(b) negotiating and agreeing upon a fee that the client will pay in exchange for the services, wherein the fee is calculated on a per unit time basis;
(c) initiating a service session using the communication device; and
(d) monitoring a duration of the service session using a tool that is accessed via a data processing system, wherein said tool:
(i) is capable of monitoring the duration of the service session which employs any of said communication device options or combinations thereof,
(ii) calculates the total fees owed by the client in real-time, wherein the total fees owed are presented in a graphical user interface within a data processing system, and
(iii) is provided with a control that enables the client or a service provider to reversibly pause the step of monitoring the duration of the service session.

22. The method of claim 21, wherein the tool is accessed within a dedicated website.

23. The method of claim 21, wherein the tool may be accessed and used within a data processing system independent of a website.

24. The method of claim 21, wherein the data processing system comprises a system that enables the client to submit payment for the total fees owed.

25. A system for delivering services, which comprises:
(a) a communication device that is selected or approved by a client among a plurality of communication device options, wherein the communication device is capable of establishing a connection with a service provider; and
(b) a data processing system, wherein the data processing system is capable of accessing and displaying a website, wherein the website presents a graphical user interface comprising:
(i) one or more controls that enable the client and service provider to negotiate and agree upon at least one term pursuant to which services will be rendered to the client; and
(ii) a tool that is capable of monitoring the duration of a service session which employs any of said communication device options or combinations thereof.

26. The system of claim 25, wherein the term is a fee that the client will pay in exchange for the services.

27. The system of claim 26, wherein the fee is (a) calculated on a per unit time basis, (b) a flat-fee arrangement, or (c) any combination thereof.

28. The system of claim 27, wherein the fee is calculated on a per unit time basis, wherein the tool calculates in real-time the fee owed by the client in exchange for the services.

29. The system of claim 28, wherein upon the service session concluding, a total fee owed by the client is calculated and accessible within the data processing system.

30. The system of claim 29, wherein the data processing system is provided with a system that enables the client to submit payment for the total fee owed.

31. The system of claim 30, wherein the total fee owed is deducted from a deposit account maintained by the client.

32. The system of claim 25, wherein the tool is provided with a control that enables the client or the service provider to reversibly pause the step of monitoring the duration of the service session.

33. The system of claim 25, wherein the services are selected from the group consisting of legal services, medical consultations, technical consultations, accounting services, fitness consultations, psychological consultations, fashion consultations, dating consultations, language instructions, musical instructions, cooking instructions, video game consultations, tutoring sessions, art consultations, interior design consultations, computer programming consultations, website design services, home repair consultations, adult entertainment services, and electronic equipment support services.

34. The system of claim 25, wherein the plurality of communication device options comprise telephony, instant messaging, electronic mail, facsimile, regular mail, blogs, chatrooms, videochat connections, videoconferencing, videochat, online collaboration workspace, VoIP, and in-person communications.

35. The system of claim 25, wherein the client selects a service provider from a provider directory, whereby the provider directory comprises a plurality of provider listings which provide information regarding each service provider.

36. The system of claim 25, wherein the tool is accessed within a dedicated website.

37. The system of claim 25, wherein the tool may be accessed and used within a data processing system independent of a website.

38. The system of claim 25, wherein negotiating and agreeing upon at least one term pursuant to which services will be rendered to the client is carried out within a data processing system, wherein the data processing system provides a graphical user interface which provides real-time quotes or bids for fees to be charged in exchange for services.

39. The system of claim 38, wherein the graphical user interface provides controls that allow service providers and clients to submit and adjust said quotes or bids.

40. The system of claim 25, wherein the data processing system is selected from the group consisting of a personal computer, a computerized kiosk, a PDA, a conventional telephone, a cellular telephone, a smart phone, a VoIP phone, and a digital media device.

41. The system of claim 40, wherein the data processing system is a personal computer.
